(19) United States
(12) Patent Application Publication
(10) Pub. No.: US 2007/0015012 A1
(43) Pub. Date: Jan. 18, 2007

(54) Process for the treatment of particles

(76) Inventors: Patrice Bujard, Courtepin/Fr (CH); Urs L. Stadler, Madison, NJ (US); Marc A. Mamak, Norwalk, CT (US); Philippe Bugnon, Le Mouret (CH); Oliver Reich, Grenzach-Wyhlen (DE)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 11/446,849

(22) Filed: Jun. 5, 2006

Related U.S. Application Data
(60) Provisional application No. 60/689,196, filed on Jun. 10, 2005.

(51) Int. Cl. G11B 5/706

(52) U.S. Cl. 428/845.1

(57) ABSTRACT

The invention relates to a process for the treatment of particles using a plasma torch and to the particles obtainable by the process. The particles so obtainable may be incorporated into coatings, plastics, paints, printing inks, ceramics, glasses or personal care products.

This application takes the benefit of U.S. Provisional Application No. 60/689,196, filed Jun. 10, 2005.

### FIELD OF THE INVENTION

The invention relates to a process for the treatment of particles using a plasma torch and to the particles obtainable by the process.

### SUMMARY OF THE INVENTION

Accordingly, the present invention relates to a process for the treatment of particles, comprising

(A) providing particles, comprising

(a) a substrate and
(b) at least one layer on the substrate; or particles, especially platelet-like particles¹⁾,
   (B) entraining said particles in a stream of gas for transport to a plasma torch;
   (C) creating a plasma in said stream of gas to heat the outer surface of the particles;
   (D) permitting said particles to cool; and
   (E) collecting said particles, and to the particles, obtainable by the process.

The treatment promotes, for example, uniform crystallinity and/or coating densification. The rapid melting and solidification for certain particles can provide enhanced properties associated with the metal oxide coating such as barrier properties, binding properties and crystalline surface formation. The short residence times in the reaction zones allow for rapid treatments. Further the processing conditions can be adjusted to selective melt and resolidify and crystallize the surface and near surface of the particles. Moreover, surface leveling can be achieved which results in a uniform surface with minimal defects. This leveling of the surface affects the reflectance characteristics of the particle, an important aspect of say a pigment flake or particle. Incident light hitting a non-uniform surface will be subject to scatter. With a more uniform surface by the process of the invention, scattering is diminished and thus reflectance properties improved.

The actual chemical functionality, such as hydroxyl groups at the surface of the treated particle may also be altered thus improving stability to light and other environmental factor.

This effect may be measured by the methylene blue test.

Methylene blue is cationic and may tether to the TiO₂ surface by ion exchange with hydroxyl protons. The photodegradation of the methylene blue tethered to the flake surface is then measured to determine the flakes effect on organic materials exposed to the surface of the flake.

As the methylene blue test gives a measure of the hydroxyl group concentration on the surface of the flake, the test also is an indirect measure of the surface area and density of the coating on the coated flake. For example, a high value of methylene blue (or high hydroxyl group concentration) sorption by methylene blue indicates that the coating of the coated flakes has a large pore volume and thus a low density. A low sorption value indicates a smoother surface with fewer pores and higher coating density. This is confirmed by surface electron micrograph (SEM).

mong other things, this may help to avoid agglomeration of particles.

The particles can, in principal, have any form. Preferred substrates are any high aspect ratio materials, such as platelets (flakes), rod-like materials and fibers. The aspect ratio is at least 10 to 1. The term “aspect ratio” refers to the ratio of the maximum to the minimum dimension of a particle.

Suitable substrates which can be used as base material, include, for example, spherical, rod-like or platelet-shaped substrates, especially preferred are natural micaceous iron oxide (for example as in WO 99/48634), synthetic and doped micaceous iron oxide (for example as in EP-A 0 068 311), mica (muscovite, phlogopite, fluorophlogopite, synthetic fluorophlogopite, talc, kaolin), basic lead carbonate, flaky barium sulfate, SiO₂, Al₂O₃, TiO₂, glass, ZnO, ZrO₂, SnO₂, BiOCl, chromium oxide, BN, MgO flakes, Si₃N₄, graphite, pearlescent pigments (including those which react under the fluidized bed conditions to nitrides, oxynitrides or by reduction to suboxides etc.) (for example EP-A-9739066, EP-A-0948571, WO99/61529, EP-A-1028146, EP-A-0763573, U.S. Pat. No. 5,858,078, WO98/53012, WO97/43348, U.S. Pat. No. 6,165,260, DE-A-1519116, WO97/46624, EP-A-0509352), pearlescent multilayer pigments (for example EP-A-0948572, EP-A-0882099, U.S. Pat. Nos. 5,958,125, 6,139,613), coated or uncoated SiO₂ spheres (for example known from EP-A-0803550, EP-A-1063265, JP-A-11322324), EP-A-0803550, EP-A-1063265, JP-A-11322324). Particularly preferred are mica, SiO₂ flakes, Al₂O₃ flakes, TiO₂ flakes, Fe₂O₃ flakes, BiOCl and glass flakes.

Glass flakes for the purpose of the invention include any of the known grades such as A-glass, E-glass (high resistivity makes E-glass suitable for electrical laminates), C-glass and ECR-glass (corrosion grade glass) materials.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### BRIEF DESCRIPTION OF THE DRAWINGS

FIG. 1: Powder XRD of Plasma processed TiO₂ coated mica (no tin oxide layer). ‘R’=Rutile Phase. Unlabeled peaks are due to the mica phase

FIG. 2: Raman spectroscopy showing the Anatase to Rutile transformation after Ar/H₂ plasma treatment. Anatase is represented by peaks at 396, 514, and 638 cm⁻¹. Rutile is represented by peaks at 447 and 611 cm⁻¹.

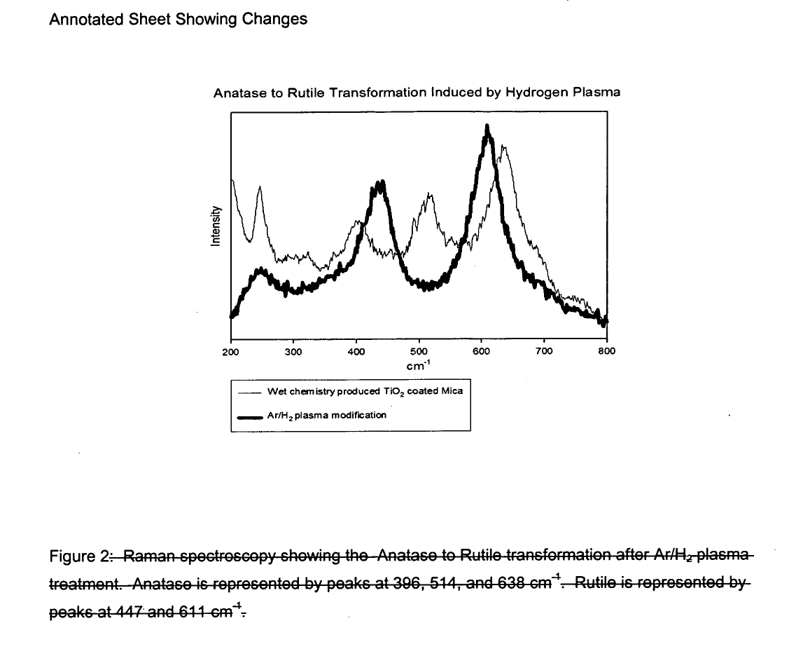

FIG. 3: Top-UV-vis spectra taken at T=0 for normalized samples (18 ppm=untreated flakes and 4 ppm for all plasma treated flakes). Bottom-UV-vis spectra taken at T=2 hrs. See example 6.

FIG. 4: Surface Electon Micrographs (SEM) images at 70 k magnification comparing the top surface of TiO₂-coated mica flakes. Left: Calcined at 650° C. in air. Center: Plasma processed, 100% Argon. Right: Plasma processed, 10 slpm H₂/250 slpm Ar. The left and center images are anatase TiO₂ The right image is rutile TiO₂. These images illustrate that the plasma processed flakes have a denser, less porous TiO₂ coating than can be achieved by calcinations and plasma conditions such as gas composition, residence time, and quench rate can influence the TiO₂ surface morphology in terms of grain size and degree of crystallinity.

### DETAILED DESCRIPTION OF THE INVENTION

The plasma torch is preferably an induction plasma torch. The preferred induction plasma torches for use in the process of the present invention are available from Tekna Plasma Systems, Inc. of Sherbrooke, Quebec, Canada. Boulos et al., U.S. Pat. No. 5,200,595, is hereby incorporated by reference for its teachings relative to the construction and operation of plasma induction torches.

The induction plasma torch used in the process is equipped with a powder feeder that operates by entraining the particles in an, upward or downward, stream of gas for transport to the plasma induction torch. In addition, it is also possible to inject the particles as a slurry (e.g. aqueous, organic solvents, such as C₁₋₄alcohols, ketones, and di-C₁-₂alkyl ethers) into the plasma reactor. This slurry is atomized at the tip of the injection probe.

In a preferred embodiment of the invention the transport gas is inert, i.e. does not react with the outer surfaces of the particles. Typically, the fluidizing gaseous medium is selected to be compatible with the particles, i.e. do not substantially adversely affect the quality of the particles. Examples of such transport gases are argon, nitrogen, helium, oxygen or mixtures such as dry air or argon/hydrogen and argon/oxygen. Generally, gases such as air, nitrogen, argon, helium and the like, can be used, with air being a gas of choice, where no substantial adverse oxidation reaction of the particles takes place.

The use of an inert gas does not exclude the thermal modification of the outer surface. The process of the present invention can be used, for example, to produce (platelet-like) particles comprising a core and at least one coating layer consisting essentially of a compound having from 60 to 95% by weight of carbon and from 5 to 25% by weight of nitrogen, the balance to 100% being selected from elements of the group consisting of hydrogen, oxygen and sulfur. For example, polyacrylonitrile (PAM) maybe coated onto the particle. When treated by the process of the invention, the PAM is converted to a carbon layer. An additional metal oxide layer may be formed on top of the carbon layer by wet chemistry.

The particles can be produced by a process, comprising

(A) providing (platelet-like) particles, comprising

(a) a core and
(b) a polymeric coating, comprising nitrogen and carbon atoms, on the surface of the flakes;
   (B) entraining said particles in a stream of gas for transport to a plasma torch;
   (C) creating a plasma in said stream of gas to heat the outer surface of the particles;
   (D) permitting said particles to cool; and
   (E) collecting said particles.

The platelet-like particles, comprising (a) a core and (b) a polymeric coating, comprising nitrogen and carbon atoms, on the surface of the flakes can be prepared as described in EP-A-0 982 376:

(a) suspending a platelet-like material in a liquid,

(b) where appropriate adding a surface-modifier and/or a polymerization catalyst,

(c), before or after step (b), adding one or more polymers comprising nitrogen and carbon atoms, or one or more monomers capable of forming such polymers,

(d) forming a polymeric coating on the surface of the platelet-like material,

(e) isolating the platelet-like material. The isolated plate-like material can be dried in an air flux or a spray dryer.

The polymer may be a polypyrrole, a polyamide, a polyaniline, a polyurethane, a nitrile rubber or a melamine-formaldehyde resin, preferably a polyacrylonitrile, or the monomer is a pyrrole derivative, an acrylonitrile, a methacrylonitrile, a crotonitrile, an acrylamide, a methacrylamide or a crotonamide, preferably an acrylonitrile, methacrylonitrile or crotonitrile, most preferably an acrylonitrile.

The compound's carbon content is preferably from 70 to 90% by weight. The hydrogen content is preferably from 0.5 to 5% by weight. The nitrogen content is preferably from 13 to 22% by weight. The sulfur content is preferably below 1% by weight, most preferably nil.

Suitable core substrates are transparent, partially reflectant, or reflectant. Examples thereof are flat metallic or silicatic particles, graphite, Fe₂O₃, MOS₂, talc or glass flakes, and plateletlike crystals of beta-phthalocyanine, fluororubine, red perylenes or diketopyrrolopyrroles. Silicatic particles are preferred, in particular light-colored or white micas, for example sericite, kaolinite, muscovite, biotite, phlogopite, or related vermiculite, or any synthetic mica.

Another preferred embodiment is the use of flat metallic particles as the core. Examples of suitable metallic particles are flakes of Ag, Al, Au, Cu, Cr, Fe, Ge, Mo, Ni, Pt, Pd, Si, Sn, Ti, or alloys thereof, such as brass or steel, preferably Al flakes. Other useful reflective materials include, but are not limited to, the transition and lanthanide metals and combinations thereof; as well as metal carbides, metal oxides, metal nitrides, metal sulfides, combinations thereof, or mixtures of metals and one or more of these materials. Depending on the material, a natural optically non-interfering oxide layer may form on the surface of metallic particle.

Partially reflecting cores have preferably a reflectance of at least 35% of the light falling vertically on its surface in the range from 380 to 800 nm.

The thickness of a reflector layer can range from about 40 nm to about 150 nm. For example, the lower limit of about 40 nm is preferably selected for an aluminum reflector layer so that the aluminum is not transparent. Other reflector materials may justify higher or lower minimum thicknesses in order to obtain a non-transparent thickness.

The instant pigments preferably also comprise an intermediate coating between the core and the nitrogen doped carbon coating, which intermediate coating may consist, for example, of one or more layers of a metal or mixed-metal oxide or oxide hydrate.

On silicatic core particles, the intermediate layer consists preferably of a metal oxide, oxide hydrate or halide such as titanium, zirconium, tin, iron, chromium or zinc oxide, bismuth oxychloride or mixtures thereof, on top which an optional protective layer may preferably also be applied to increase the stability, for example a layer of a metal oxide such as silicon or aluminium oxide after the plasma treatment. Of particular importance are micas, which are coated with highly refractive colorless metal oxides or oxide hydrates. Particularly preferred are intermediate coatings of zirconium dioxide or titanium dioxide; very particularly preferred is a coating of titanium dioxide. A very particular interest is given to micas having a dielectric coating layer of thickness from 0.03 to 0.3 μm.

On metallic flakes, the intermediate layer consists preferably of a metal oxide, oxide hydrate or halide such as titanium, zirconium, tin, iron, chromium or zinc oxide, bismuth oxychloride or mixtures thereof. Particularly preferred is a coating of silicon dioxide.

Particles coated with the above intermediate layers and their use as effect pigments are generally known per se, for example from DE 14 67 468, EP 0 045 851, DE 32 37 264, DE 36 17 430, EP 0 298 604, EP 0 388 932 and EP 0 402 943. Metal oxide-coated mica platelets are also commercially available unter the names Iriodin® (E. Merck, Darmstadt), Flonac® (Kemira Oy, Finland), Mearlin® (Mearl Corporation, New York/USA) and Infinite Color® (Shisheido, Japan). Coated metal flakes are also commercially available under the names Chroma Flair® (Flex Products, Inc, Santa Rosa, Calif./USA) and Paliochrom® (BASF, Germany). The size of the core particles is not critical per se and can be adapted to the particular use. Generally, the particles have a length from about 1 to 200 μm, in particular from about 5 to 100 μm, and thicknesses from about 0.05 to 5 μm, preferably from 0.1 to 2 μm, in particular about 0.5 μm. Particles having a platelet-like shape are understood to be such having two essentially flat and parallel surfaces, with an aspect ratio length to thickness of from about 2:1 to about 1000:1, and a length to width ratio of from 3:1 to 1:1.

The nitrogen doped carbon coating has for example a thickness of from 1 nm to 1 μm, preferably of from 1 nm to 300 nm, most preferred 10 to 150 nm.

In another preferred embodiment of the invention the transport gas is a reactive gas (reaction gas) or comprises a reactive gas, i.e. is used to modify the outer surface of the particles.

Gases used to modify the outer surface of the particles are for example, reducing gases such as ammonia, hydrogen, methane, carbon monoxide, other hydrocarbons such as methane, propane and butane and mixtures thereof.

Reduced titania-coated luster pigments whose TiO₂ coating comprises or has been wholly converted to reduced titanium species (oxidation state of the titanium: from <4 to 2) have long been known as “dark pearl luster pigments” for the blue to black hue range for example in U.S. Pat. No. 5,624,487.

These bluish black pigments, may be made by the process of the invention by treating titanium dioxide coated particles or flakes with any of the above reducing gases, in a nonoxidizing atmosphere in the plasma chamber thus achieving particles or flakes comprising coated titanium dioxide flakes and titanium suboxides.

It is also possible to treat the titanium dioxide coated particle or flake in the plasma chamber with solid reducing agents in the form of metal powders, alloys of metals, metal borides, metal carbides or metal silicides.

The reduction reaction may be accelerated in the presence of a halide for example, lithium chloride, sodium chloride, potassium chloride, magnesium chloride, iron chlorides or chromium chloride.

In said embodiment the transport gas is, for example, a mixture of about 80-90% argon, with the balance being hydrogen. By using said mixture of argon and hydrogen as transport gas it is, for example, possible to convert a titanium dioxide layer, at least partially, to a titanium suboxide layer.

Another example of a reactive transport gas is ammonia. By using ammonia metal nitride/oxy nitride coated substrates can be produced.

There are several points in the embodied process where the gases may be introduced into the plasma chamber in order to achieve a particular effect on the surface of the particle. For example, the gas or gases may be introduced in the carrier, dispersion or quench gas streams.

The synthesis of the new pigments is divided into two steps. The first step is the synthesis of a precursor and the second a conversion process carried out by using the process of the present invention.

The precursor is preferably produced in an aqueous precipitation process such as described for example in U.S. Pat. Nos. 3,087,828, 3,087,829, DE-A-1959998, DE-A-2009566, DE-A-2214545, DE-A-2244298, DE-A-2313331, DE-A-2522572, DE-A-3137808, DE-A-3137809, DE-A-3151343, DE-A-3151354, DE-A-3151355, DE-A-3211602, DE-A-3235107, WO93/08237 and EP-A-0763573. Halide, carbonate, oxalate, chloride, oxychloride or alcoholate solutions are used to precipitate oxides, respectively, mixed oxides onto substrates. The reaction parameters such as temperature, pH, agitation velocity and reactor geometry are optimized to yield a flat continuous layer of insoluble oxides and/or hydroxides on the substrates. The mixed oxides are co-precipitated onto the substrates following an analogous process.

A wide range of precursors can also be synthesized using dopant ions, such as silicon, vanadium, chromium, aluminum, cerium, neodymium, praseodymium, sulfur, selenium, cobalt, nickel, zinc and phosphate ions, co-precipitated into the oxide respectively hydroxide layers. The dopants can be used to create color effects (like rare earth, vanadium, or cobalt ions) as well as for the control of grain growth (like SiO₂ or aluminum oxide) during the subsequent reaction with the reaction gas, such as ammonia.

In the second step the precursors obtained in the above first step are converted into nitrides/oxynitrides. A suitable mixture of gases consists of at least one inert and one reaction gas. Examples of useful reaction gases are N₂, or N₂/H₂, but preferably ammonia. Suitable inert gases are Ar, H₂/CO/N₂. The gas composition may vary from >0 to 100 vol.-%, preferably from 20 to 80 vol.-% of reaction gas in inert gas.

For example, precursors coated with TiO₂ may be modified partially to TiN in a suitable mixture of Ar/N₂ gas in the plasma torch. Where only small quantities of the TiO₂ are converted to TiN on the surface, the TiN may act as a semi-transparent coating and hence give new colors when combined with the interference spectrum of a three layer structure.

Furthermore, a TiN layer of a couple nanometers over the TiO₂ sublayer may improve the surface of the precusor by improving color and decreasing the photoactivity of the TiO₂ sublayer. When the precursor coated with TiO₂ is reduced enough to form a relatively thick layer of TiN (>10 nm) a bright gold color is possible.

The conversion from oxides/mixed oxides to nitrides/oxynitrides is carried out depending on the different parameters, such as gas flow rates, reaction time or temperature profiles. The longer the reaction time the higher the nitride-to-oxynitride ratio. Consequently the reaction time determines the obtained structure of the compound.

Suitable substrates which can be used as base material, include, for example, spherical or platelet-shaped substrates, especially preferred are natural micaceous iron oxide (WO99/48634), synthetic and doped micaceous iron oxide (for example as in EP-A 0 068 311), mica (muscovite, phlogopite, fluorophlogopite, synthetic fluorophlogopite, talc, kaolin), basic lead carbonate, flaky barium sulfate, SiO₂, Al₂O₃, TiO₂, glass, ZnO, ZrO₂, SnO₂, BiOCl, chromium oxide, BN, MgO flakes, Si₃N₄, graphite, pearlescent pigments (including those which react under the fluidized bed conditions to nitrides, oxynitrides or by reduction to suboxides etc.) (EP-A-9739066, EP-A-0948571, WO99/61529, EP-A-1028146, EP-A-0763573, U.S. Pat. No. 5,858,078, WO98/53012, WO97/43348, U.S. Pat. No. 6,165,260, DE-A-1519116, WO97/46624, EP-A-0509352), pearlescent multilayer pigments (for example EP-A-0948572, EP-A-0882099, U.S. Pat. Nos. 5,958,125, 6,139,613), coated or uncoated SiO₂ spheres (for example known from EP-A-0803550, EP-A-1063265, JP-A-11322324), EP-A-0803550, EP-A-1063265, JP-A-11322324). Particularly preferred are mica, SiO₂ flakes, Al₂O₃ flakes, TiO₂ flakes, Fe₂O₃ flakes, BiOCl and glass flakes.

It does not matter how the substrate is made. For example, the Al₂O₃ substrate may be made according to the process described in U.S. Pat. No. 5,702,519, wherein the Al₂O₃ formed is a flake of a high aspect ratio. U.S. Pat. Nos. 6,203,768, 6,503,475 or European application no. 1,611,057 also discuss methods of making particles, wherein the particles are mechanically milled in a multiphase allegedly giving control over the particle size and distribution.

The layer(s) that is (are) precipitated onto the substrates and then converted result in the following nitrides and/or oxynitrides, for example:

in case of nitrides:

1) binary nitrides of the formula

AₓN_{y} with A=Ta, Ti, Zr, Si, Al, V, Nb, Cr, Mn, W, Mo, Fe, Li, Mg, Ca, Sr, Zn, Ga, P, in particularly Ta₃N₅, Zr₃N₄, Si₃N₄, Fe₃N, GaN, CrN

0<x, 0<y

2) ternary nitrides of the formula

AₓB_{y}N_{z} such as NaPN₂, NaGe₂N₃, MgSiN₂, BeSiN₂, MgSiN₂, MnSiN₂, MgGeN₂, MnGeN₂, ZnGeN₂, LiSi₂ N₃, LiGe₂N₃, NaGe₂N₃, Mg₂PN₃, Mn₂PN₃, Zn₂PN₃, LaSi₃N₅, CrYN, CrScN, CrLaN,

0<x, 0<y, 0<z Li₂ₙ₋₃MₙNₙ₋₁ with the oxidation state n of the metal M ranging from 2 to 6, such as LiMgN, LiZnN, Li₃AlN₂, Li₃GaN₂, Li₅SiN₃, Li₇VN₄, Li₇MnN₄, Li_{g}CrN₅, Li₂ZrN₂, Li₂CeN₂, Ca₂ ZnN₂,

in case of oxynitrides:

1) oxynitrides based on one metal

AₓO_{y}N_{z}, with A=Ta, Ti, Al, Zr, Nb, Si, P, Hf, in particularly Zr₇O₈N₄, Zr₂ON₂, Zr₇O₁₁N₂, HF₂ON₂, Al₃O₃N, Ga₁₋ₓ/3 N₁₋ₓOₓ with 0<x<1

0<x, 0<y, 0<z

2) oxynitrides based on two metals

ABO₂N, with A=Lanthanide, B=Si, particularly: LaSiO₂N₂

ABO₂N, with A=Ca, Sr or Ba B=Ta or Nb particularly: CaTaO₂N, SrTaO₂N, SrNbO₂N, BaTaO₂N, BaNbO₂N

ABON₂, with A=Lanthanide, B=Ta, Nb, particularly: LaTaON₂

ABON, with A=alkaline and B=Ge or Si particularly: NaGeON, KGeON, LiSiON, NaSiON

A₂ BO₃N, with A=Ca, Sr, Ba and B=Ta, Nb

ABO₃₋ₓNₓ, with A=Li⁺, Na⁺, K⁺, Rb⁺, Cs⁺, Ba²⁺, Sr²⁺, Pb²⁺, Ln³⁺ (=rare earth), Bi³⁺, Y³⁺B=W⁶⁺, Re⁶⁺, Mo⁵⁺, Ta⁵⁺, Nb⁵⁺, Mo⁵⁺, W⁵⁺, Zr⁴⁺, Sn⁴⁺, Ge⁴⁺, Nb⁴⁺, Ta⁴⁺, Al³⁺, Ga³⁺, Ln³⁺(=rare earth), Fe³⁺, Cr³⁺ and with x=1, 2 or 3 and the electronic charges a of A and b of B verify a+b=6+x; a≧x and solid solutions of these compounds

ABO₃N with A=K or Cs, B=Os particularly: KOsO₃N, RbOsO₃N, CsOsO₃N

A₂BO₃N with A=Sr or lanthanide, B=Ta particularly: Sr₂TaO₃N

2Li₁₊ₓGe₂−xO₃ₓN₃₋₃ₓ

(0<x<1)

LnWOₓN₃₋ₓ with Ln=La and Nd and 0.6<x<0.8

LnWO₃N with Ln=Nd, Sm, Gd, Dy

Ln_{2.67}W_{1.33}O_{3.8}N_{2.8}, Ln₁₄W₄O₃₃₋₃ₓN₂ₓ, and Ln₆W₄O₁₂₋₃ₓN₂ₓ with 0<x with Ln=Ho, La, Nd, Sm, Y, Yb, and other alike defect compounds having a structure of A₄X_{6.6}Δ_{1.4} and A₄X_{7.33 to 6.85} Δ_{0.67 to 1.15,} in which A=cations such as rare earth and tungsten, X=oxygen and nitrogen as anions, and Δ is a defect.

Ln₂AlO₃N with Ln=La, Nd, Sm

Ln₁₀Si₆O₂₄N₂ with Ln=La, Ce, Nd, Sm, Gd and Y

Ln₂Si₃O₃N₄ with Ln=La—Yb and Y

Zr₍ₓ₎Ta₍₃₋ₓ₎O₍ₓ₎N₍₅₋ₓ₎ with 0≦x≦0.66

Ta₍₁₋ₓ₎Zr₍ₓ₎N₍₁₋ₓ₎O₍₁₊ₓ₎ with 0≦x≦0≦x≦0.28

3) oxynitrides based on three metals

AZrₓTa₁₋ₓO₂₊ₓN₁₋ₓ with A=Ca, Sr, Ba, 0<x<1

LiNaPON, Re₆ WV₂₊ₓO₁₂₋₃ₓN₂ₓ with 0<x

Ln₈Cr₂Si₆O₂4N₂ with Ln=La—Dy (i.e., an element between La and Dy, inclusive, in the Periodic Table)

Ln₈M^{IV}₂Si₆N₄O₂₂ with Ln=La—Dy and M^{IV}=Ti or Ge

LnEu^{II}SiO₃N with Ln=La, Nd, Sm

Ln₄Si₂N₂O₇ with Ln=Nd—Yb (i.e., an element between Nd and Yb, inclusive, in the Periodic Table) and Y

Pyrochlore structure: AₓA′₂₋ₓB₂O₅₊ₓN₂₋ₓ or A′₂B_{2-y}B′_{y}O_{5+y}N_{2-y}

A=Mg²⁺, Ca²⁺, Sr²⁺, Ba²⁺, Zn²⁺

A′=Ln³⁺ (=rare earth), Bi³⁺, Al³⁺, Fe³⁺

B=V⁵⁺, Nb⁵⁺, Ta⁵⁺, Mo⁵⁺, W⁵⁺

B′=Zr⁴⁺, Hf⁴⁺, Sn⁴⁺, Ge⁴⁺, Si⁴⁺, Nb⁴⁺, Ta⁴⁺

0≦x, y<2, with the exception Ln₂TaO₅N₂

Spinel structure: CD₂₋ₘD′ₘO₄₋ₘNₘ or C₁₋ₙC′ₙD₂O₄₋ₙNₙ

C=Mg²⁺, Ca²⁺ Mn²⁺Fe²⁺, Co²⁺, Ni²⁺, Zn²⁺

D=Al³⁺, Ga³⁺, In³⁺, Ti³⁺, V³⁺, Cr³⁺, Fe³⁺, Co³⁺, Ni³⁺

D′=Zr⁴⁺, Hf⁴⁺, Sn⁴⁺, Ge⁴⁺, Si⁴⁺, Nb⁴⁺, Ta⁴⁺

C′=Al³⁺, Ga³⁺, In³⁺, Ti³⁺, V³⁺, Cr³⁺, Fe³⁺, Co³⁺, Ni³

0<m<2, 0<n≦1

Elpasolite structure: A′₂QBO_{5-z}, N₁₊

z=0 Q=C (bivalent metallic ion) A′₂CBO₅N

z=1 Q=A″ (trivalent metallic ion) A′₂A″BO₄N₂

z=2 Q=D″ (tetravalent metallic ion)

A′₂D″BO₃ N₃

A′, B, C and D are defined above and

A″ represents Ln³⁺ (=rare earth) or Bi³⁺

D″ denotes a tetravalent metal ion

Perovskite structure: A₁₋ᵤA′ᵤBO₂₋ᵤN₁₊ᵤ or A′B_{1-w}B′_{w}O_{1+w}N_{2-w}

A=Mg²⁺, Ca²⁺, Si²⁺, Ba²⁺

A′=Ln³⁺ (=rare earth), Bi³⁺, Al³⁺, Fe³⁺

B=V⁵⁺, Nb⁵⁺, Ta⁵⁺

B′=Zr⁴⁺, Hf⁴⁺, Sn⁴⁺, Ge⁴⁺

0≦u<1; 0<w≦1, with the exception Ln₂TaON₂

The thickness of the nitride respectively oxynitride layers can vary, for example, between 5 and 500 nm, yielding slight shades and flat angle color effect at low thicknesses and very pronounced hiding at high thicknesses. For the optimal interference effect, the preferred thicknesses are 50-350 nm, especially preferred 80-200 nm.

Preferred pearlescent pigments of the present invention are given in the following: substrate+titanium nitride, substrate+titanium oxynitride, substrate+TiO₂ substrate+TiO_{suboxides} substrate+TaₓO_{y}N_{z}, preferably TaON (x=y=z=1), substrate+ZrₓO_{y}N_{z}, preferably Zr₂ON₂ or Zr₇O₈N₄, substrate+V doped ZrₓO_{y}N_{z}, preferably V-doped Zr₂ON₂ or Zr₇O₈N₄, substrate+LaTaON₂, substrate+Pr doped ZrₓO_{y}N_{z}, preferably Pr-doped Zr₂ON₂ or Zr₇O₈N₄, substrate+CaTaO₂N, substrate+SrTaO₂Nsubstrate+Zr₂ON₂, substrate+Zr₇O₈N₄, substrate+Ta₃N₅, substrate+TaON, substrate+ZrV₂O₄N₂, substrate+ZrPr₆O₁₀N₂, substrate+TiON+Ta₃N₅, substrate+TiO₂+TiN, substrate+TiO₂+TiON, substrate+TiO₂+TiO_{suboxides}, substrate+Ta₃N₅+TiO₂, substrate+TiO₂+SiO₂+Ta₃N₅, substrate+Zr₂ON₂+TiO₂, substrate+TiON+Zr₂ON₂, substrate+TiO₂+Zr₂ON₂.

The symbol TiO_{suboxides} is a reference to titanium suboxides (TiO₂ partially reduced with oxidation states of from <4 to 2 and lower oxides, such as Ti₃O₅, Ti₂O₃ up to TiO)

Especially preferred pigments are given in the following:

mica+titanium nitride, mica+titanium oxynitride, Mica+TiO₂, Mica+TiO_{suboxides}, Mica+TaₓO_{y}N_{z}, Mica+ZrₓO_{y}N_{z}, Mica+V doped ZrₓO_{y}N_{z}, Mica+LaTaON₂, Mica+Pr doped ZrₓO_{y}N_{z}, Mica+CaTaO₂N, Mica+SrTaO₂N, Mica+Zr₂ON₂, Mica+Zr₇O₈N₄, Mica+Ta₃N₅, Mica+TaON, Mica+ZrV₂O₄N₂, Mica+ZrPrO₁₀N₂, Mica+TiON+Ta₃N₅, Mica+TiO₂+TiO_{suboxides}, Mica+Ta₃N₅+TiO₂, Mica+TiO₂+SiO₂+Ta₃N₅, Mica+Zr₂ON₂+TiO₂, Mica+TiON+Zr₂ON₂, Mica+TiO₂+Zr₂ON₂, SiO₂ flakes+titanium nitride, SiO₂ flakes+TiO_{suboxides}, SiO₂ flakes+titanium oxynitride, SiO₂ flakes+TaₓO_{y}N_{z}, SiO₂ flakes+ZrₓO_{y}N_{z}, SiO₂ flakes+V doped ZrₓO_{y}N_{z}, SiO₂ flakes+LaTaON_{z}, SiO₂ flakes+Pr doped ZrₓO_{y}N_{z}, SiO₂ flakes+CaTaO₂N, SiO₂ flakes+SrTaO₂N, SiO₂ flakes+Zr₂ON₂, SiO₂ flakes+Zr₇O₈N₄, SiO₂ flakes+Ta₃N₅, SiO₂ flakes+TaON, SiO₂ flakes+ZrV₂O₄N₂, SiO₂ flakes+ZrPr₆O₁₀N₂, SiO₂ flakes+TiO₂+TiN, SiO2 flakes+TiO₂+TiO_{suboxides} SiO₂ flakes+TiON+Ta₃N₅, SiO₂ flakes+Ta₃N₅+TiO₂, SiO₂ flakes+TiO₂+SiO₂+Ta₃N₅, SiO₂ flakes+Zr₂ON₂+TiO₂, SiO₂ flakes+TiON+Zr₂ON₂, SiO₂ flakes+TiO₂+Zr₂ON₂, Al₂O₃ flakes+titanium nitride, Al₂O₃ flakes+titanium oxynitride, Al₂O₃ flakes+TiO₂, Al₂O₃ flakes+TiO_{suboxides}, Al₂O₃ flakes+TaₓO_{y}N_{z}, Al₂O₃ flakes+ZrₓO_{y}N_{z}, Al₂O₃ flakes+V doped ZrₓO_{y}N_{z}, Al₂O₃ flakes+LaTaON_{z}, Al₂O₃ flakes+Pr doped ZrₓO_{y}N_{z}, Al₂O₃ flakes+CaTaO₂N, Al₂O₃ flakes+SrTaO₂N, Al₂O₃ flakes+Zr₂ON₂, Al₂O₃ flakes+Zr₇O₈N₄, Al₂O₃ flakes+Ta₃N₅, Al₂O₃ flakes+TaON, Al₂O₃ flakes+ZrV₂O₄N₂, Al₂O₃ flakes+ZrPr₆O₁₀N₂, Al₂O₃ flakes+TiON+Ta₃N₅, Al₂O₃ flakes+TiO₂+TiN, Al₂O₃ flakes+TiO₂+TiO_{suboxides}, Al₂O₃ flakes+Ta₃ N₅+TiO₂, Al₂O₃ flakes+TiO₂+SiO₂+Ta₃N₅, Al₂O₃ flakes+Zr₂ON₂+TiO₂, Al₂O₃ flakes+TiON+Zr₂ ON₂, Al₂O₃ flakes+TiO₂+Zr₂ ON₂, TiO₂ flakes+titanium nitride, TiO₂ flakes+titanium oxynitride, TiO₂ flakes+TiO_{suboxides}, TiO₂ flakes+Taₓ O_{y} N_{z}, TiO₂ flakes+Zrₓ O_{y} N_{z}, TiO₂ flakes+V doped Zrₓ O_{y} N_{z}, TiO₂ flakes+LaTaON_{z}, TiO₂ flakes+Pr doped Zrₓ O_{y} N_{z}, TiO₂ flakes+CaTaO₂N, TiO₂ flakes+SrTaO₂N, TiO₂ flakes+Zr₂ ON₂, TiO₂ flakes+Zr₇O₈N₄, TiO₂ flakes+Ta₃N₅, TiO₂ flakes+TaON, TiO₂ flakes+ZrV₂O₄N₂, TiO₂ flakes+ZrPr₆O₁₀N₂, TiO₂ flakes+TiON+Ta₃N₅, TiO₂ flakes+Ta₃N₅+TiO₂, TiO₂ flakes+TiO₂+SiO₂+Ta₃N₅, TiO₂ flakes+Zr₂ON₂+TiO₂, TiO₂ flakes+TiON+Zr₂ON₂, TiO₂ flakes+TiO₂+Zr₂ON₂, Fe₂O₃ flakes+titanium nitride, Fe₂O₃ flakes+titanium oxynitride, Fe₂O₃ flakes+TaₓO_{y}N_{z}, Fe₂O₃ flakes+TiO₂ Fe₂O₃ flakes+TiO_{suboxides}, Fe₂O₃ flakes+ZrₓO_{y}N_{z}, Fe₂O₃ flakes+V doped ZrₓO_{y}N_{z}, Fe₂O₃ flakes+LaTaON_{z}, Fe₂O₃ flakes+Pr doped ZrₓO_{y}N_{z}, Fe₂O₃ flakes+CaTaO₂N, Fe₂O₃ flakes+SrTaO₂N, Fe₂O₃ flakes+Zr₂ON₂, Fe₂O₃ flakes+Zr₇O₈N₄, Fe₂O₃ flakes+Ta₃N₅, Fe₂O₃ flakes+TaON, Fe₂O₃ flakes+ZrV₂O₄N₂, Fe₂O₃ flakes+ZrPr₆O₁₀N₂, Fe₂O₃ flakes+TiON+Ta₃N₅, Fe₂O₃ flakes+Ta₃N₅+TiO₂, Fe₂O₃ flakes+TiO₂+SiO₂+Ta₃N₅, Fe₂O₃ flakes+Zr₂ON₂+TiO₂, Fe₂O₃ flakes+TiON+Zr₂ON₂, Fe₂O₃ flakes+TiO₂+Zr₂ON₂, Fe₂O₃ flakes+TiO₂+TiN, Fe₂O₃ flakes+TiO₂+TiO_{suboxides}, BiOCl flakes+titanium nitride, BiOCl flakes+titanium oxynitride, BiOCl+TaₓO_{y}N_{z}, BiOCl+ZrₓO_{y}N_{z}, BiOCl+V doped ZrₓO_{y}N_{z}, BiOCl+LaTaON_{z}, BiOCl+Pr doped ZrₓO_{y}N_{z}, BiOCl+CaTaO₂N, BiOCl+SrTaO₂N, BiOCl+Zr₂ON₂, BiOCl+Zr₇O₈N₄, BiOCl+Ta₃N₅, BiOCl+TaON, BiOCl+ZrV₂O₄N₂, BiOCl+ZrPr₆O₁₀N₂, BiOCl+TiON+Ta₃N₅, BiOCl+Ta₃N₅+TiO₂, BiOCl+TiO₂+SiO₂+Ta₃N₅, BiOCl+Zr₂ON₂+TiO₂, BiOCl+TiON+Zr₂ON₂, BiOCl+TiO₂+Zr₂ON₂, BiOCl+TiO₂+TiN, Mica+TiO₂+titanium nitride, Mica+TiO₂+titanium oxynitride, Mica+TiO₂+TaₓO_{y}N_{z}, Mica+TiO₂+ZrₓO_{y}N_{z}, Mica+TiO₂+V doped ZrₓO_{y}N_{z}, Mica+TiO₂+LaTaON_{z}, Mica+TiO₂+Pr doped ZrₓO_{y}N_{z}, Mica+TiO₂+CaTaO₂N, Mica+TiO₂+SrTaO₂N, Mica+TiO₂+Zr₂ON₂, Mica+TiO₂+Zr₇O₈N₄, Mica+TiO₂+Ta₃N₅, Mica+TiO₂+TaON, Mica+TiO₂+ZrV₂O₄N₂, Mica+TiO₂+ZrPr₆O₁₀N₂, Mica+TiO₂+TiON+Ta₃N₅, Mica+TiO₂+Ta₃N₅+TiO₂, Mica+TiO₂+TiO₂+SiO₂+Ta₃N₅, Mica+TiO₂+Zr₂ON₂+SiO₂+TiO₂, Mica+TiO₂+TiON+Zr₂ON₂, Mica+TiO₂+TiO₂+Zr₂ON₂, Mica+TiO₂+SiO₂+TiO₂+TaₓO_{y}N_{z}, Mica+TiO₂+SiO₂+SiO₂+TiO₂+ZrₓO_{y}N_{z}, Mica+TiO₂+SiO₂+TiO₂+V doped ZrₓO_{y}N, Mica+TiO₂+SiO₂+TiO₂+LaTaON₂, Mica+TiO₂+SiO₂+TiO₂+Pr doped ZrO_{y}N, Mica+TiO₂+SiO₂+TiO₂+CaTaO₂N, Mica+TiO₂+SiO₂+TiO₂+SrTaO₂N, Mica+TiO₂+SiO₂+TiO₂+Zr₂ON₂, Mica+TiO₂+SiO₂+TiO₂+Zr₇O₈N₄, Mica+TiO₂+SiO₂+TiO₂+Ta₃N₅, Mica+TiO₂+SiO₂+TiO₂+TaON, Mica+TiO₂+SiO₂+TiO₂+ZrV₂O₄N₂, Mica+TiO₂+SiO₂+TiO₂+ZrPr₆O₁₀N₂, Mica+TiO₂+SiO₂+TiO₂+TiON+Ta₃N₅, Mica+TiO₂+SiO₂+TiO₂+Ta₃N₅+TiO₂, Mica+TiO₂+SiO₂+TiO₂+TiO₂+SiO₂+Ta₃N₅, Mica+TiO₂+SiO₂+TiO₂+Zr₂ON₂+TiO₂, Mica+TiO₂+SiO₂+TiO₂+TiON+Zr₂ON₂, Mica+TiO₂+SiO₂+TiO₂+TiO₂+Zr₂ON₂,

Titanium nitride coated substrates can be used as conductive pigments.

Substrates coated with metal oxide and carbon-containing compounds may be reacted with gaseous and solid hydrocarbons under O₂ free conditions either to reduce the metal oxide but also to precipitate carbon. The reduced metal oxide might be for example Fe₂O₃, SnO, SnO₂, Ag₂O, CuO, Ce₂O3, CeO₂ TiO_{suboxides} or mixtures thereof. The direct decomposition of carbon-containing compounds under a reducing atmosphere makes it possible to deposit directly very finely divided carbon particles in the desired amount to produce special color effect or to produce extremely wear-resistant coatings. (For example, see U.S. Pat. No. 5,271,771).

The gas flow rate is typically selected to obtain fluidization and charge transfer to the powder. Fine powders require less gas flow for equivalent deposition. It has been found that small amounts of water vapor enhance charge transfer.

The time for contacting the particles is generally a function of the substrate bulk density, thickness, powder size and gas flow rate. Particularly the geometry of the substrate, such as, for example, spheres, flakes, short fibers and other similar particles.

An induction plasma torch includes a reaction zone through which the entrained particles pass. The reaction zone temperature is preferably well above the melting point of the highest melting component of the outer layer of the particles and preferably below the vaporization point of the lowest vaporizing component of the layer to enable a relatively short residence time in the reaction zone. As the particles pass through the reaction zone, the outer surfaces of the particles melt, at least in part. Preferably, the flakes pass through the torch at a flow rate that minimizes interparticle contact and coalescence.

Because the outer surfaces of the particles are melted while entrained in a gas, the obtained particles have a smooth outer surface. After melting, the particles fall through a distance sufficient to permit cooling and at least partial solidification prior to contact with a solid surface or each other. While any of several methods may be used to achieve this result, it has been found convenient to feed the particles having the molten surface while still entrained in the transport gas into a liquid cooled chamber containing a gaseous atmosphere.

Various coating processes can be utilized in forming coating layers. Suitable methods for forming the coating layer include vacuum vapor deposition, sol-gel hydrolysis, CVD in a fluidized bed (U.S. Pat. No. 5,364,467 and U.S. Pat. No. 5,763,086), and electrochemical deposition. Another depositing method is the plasma enhanced chemical vapor deposition (PECVD) where the chemical species are activated by a plasma. Such a method is disclosed in detail in WO02/31058. Preferred are the wet chemical coating methods developed for the production of pearlescent pigments which are described, for example, in DE-A-14 67 468, DE-A-19 59 988, DE-A-20 09 566, DE-A-22 14 545, DE-A-22 15 191, DE-A-22 44 298, DE-A-23 13 331, DE-A-25 22 572, DE-A-31 37 808, DE-A-31 37 809, DE-A-31 51 343, DE-A-31 51 354, DE-A-31 51 355, DE-A-32 11 602 and DE-A-32 35 017, DE 195 99 88, WO 93/08237, and WO 98/53001 and wet chemical coating methods using microwave radiation which are described, for example, in WO2004111298 and WO2004113455.

If the particles comprise (a) a substrate and (b) at least one layer on the substrate; the layer (b) is preferably deposited by a wet chemical method.

While the particles can, in principal, have any form, preferred substrates are any high aspect ratio materials, such as platelets (flakes), rod-like materials and fibers. The aspect ratio is at least 10 to 1. The term “aspect ratio” refers to the ratio of the maximum to the minimum dimension of a particle.

The plate-like particles (flakes, parallel structures) generally have a length of from 1 μm to 5 mm, a width of from 1 μm to 2 mm, and a thickness of from 20 nm to 2 μm, and a ratio of length to thickness of at least 2:1, the particles having two substantially parallel faces, the distance between which is the shortest axis of the core.

The flakes of the present invention are not of a uniform shape. Nevertheless, for purposes of brevity, the flakes will be referred to as having a “diameter”. The flakes have a thickness of from 20 to 2000 nm, especially from 50 to 1000 nm. It is presently preferred that the diameter of the flakes be in a preferred range of about 1-60 μm with a more preferred range of about 5-40 μm. Thus, the aspect ratio of the flakes of the present invention is in a preferred range of about 2.5 to 625.

Once the flake is treated by the process of the invention, some spherical particles may be formed. These may be removed by simple sedimentation if desired.

In preferred embodiment the process of the invention is used for the treatment of particles comprising (a) a substrate and (b) a conductive layer including metal oxides doped with different kind of elements, such as tin oxides doped with antimony, phosphorus or fluorine of 0.1-30 wt %, preferably 3-15 wt % and tin oxides doped with tellurium of 0.01-5 wt % preferably 0.05-0.5 wt %, indium oxide system ones such as indium oxides doped with 0.1-20 wt % of tin, CdSnO₃, Cd₂SnO₄, In₂TeO₆, CdIn₂O₄, CdIn₍₂₋ₓ₎ SnₓO₄ (x=0.001-0.2), Cd₂Sn_{(1-y)}Sb_{y}O₄ (y=0.001-0.1), and In₂Te_{0.98}Re_{0.02}O₆.

Suitable substrates are any high aspect ratio materials, such as platelets, flakes, rod-like materials and fibers (e.g. glass flakes, platelet-like layered silicates, mineral or ceramic fibers). The aspect ratio is at least 10 to 1.

Preferred are transparent platelet-like substrates, such as for example, mica or glass, with a conductive layer (b) (EP-A-139557), or platelet-like pigments, in which a platelet-like substrate is coated with an electrically conductive layer (b), wherein a platelet-like metal oxide or a platelet-like material coated with one or more metal oxides is present as the platelet-like substrate and an optionally hydrated silicon dioxide layer or a layer of another insoluble silicate is optionally arranged between the metal oxide layer and the conductive layer (b) (EP-A-373575).

In principle all platelet-like effect pigments, such as, for example, platelet-like iron oxide, bismuth oxychloride or platelet-like materials coated with colored or colorless metal oxides, such as, for example, natural or synthetic micas, other laminated silicates such as talc, kaolin or sericite or glass platelets can be used as platelet-like substrates. Mica flakes coated with metal oxides such as are disclosed, for example, in U.S. Pat. Nos. 3,087,828 and 3,087,829 are particularly preferred as substrates. Metal oxides are both colorless, highly refractive metal oxides, such as, in particular, titanium dioxide and/or zirconium dioxide, as well as colored metal oxides, such as, for example, chromium oxide, nickel oxide, copper oxide, cobalt oxide and in particular iron oxides, such as, for example, Fe₂O₃, or Fe₃O₄, or mixtures of such metal oxides. Such metal oxide/mica pigments are commercially available under the tradenames Afflair® and Iriodin®. According to EP-A-373575 these substrates are coated with an optionally hydrated silica layer or with a layer of another insoluble silicate such as, for example, aluminum silicate.

The application of the conductive layer (b) is effected in a manner known per se, for example in accordance with the wet chemical process describe in EP-A 139,557 and EP-A-373575. All conventional conductive metal oxides or mixtures of metal oxides can be used for this application. A selection of such materials is given in EP-A 139,557 on page 5, lines 5-19. However, a conductive layer of tin dioxide doped with antimony is preferred, which is applied to the platelet-like substrate in an amount of about 25-100% by weight relative to the lamellar substrate and in particular in an amount of about 50-75% by weight. A tin/antimony ratio of about 2:1 to 20:1, preferably of about 5:1 to about 10:1 is preferably maintained in the coating. Phosphorus or fluoride can also be used as dopant.

In another preferred embodiment the process of the present invention is used for the treatment of effect pigments. Effect pigments are metallic or non-metallic, inorganic platelet-shaped particles or pigments (especially metal effect pigments or interference pigments), that is to say, pigments that, besides imparting colour to an application medium, impart additional properties, for example angle dependency of the colour (flop), lustre (not surface gloss) or texture. On metal effect pigments, substantially oriented reflection occurs at directionally oriented pigment particles. In the case of interference pigments, the colour-imparting effect is due to the phenomenon of interference of light in thin, highly refractive layers.

Suitable substrates which can be used as base material, include, for example, platelet-shaped substrates, especially preferred are natural micaceous iron oxide (for example as in WO 99/48634), synthetic and doped micaceous iron oxide (for example as in EP-A 0 068 311), mica (muscovite, phlogopite, fluorophlogopite, synthetic fluorophlogopite, talc, kaolin), basic lead carbonate, flaky barium sulfate, SiO₂, Al₂O₃, TiO₂, glass, ZnO, ZrO₂, SnO₂, BiOCl, chromium oxide, BN, MgO flakes, Si₃N₄, graphite, pearlescent pigments (including those which react under the fluidized bed conditions to nitrides, oxynitrides or by reduction to suboxides etc.), pearlescent multilayer pigments (for example EP-A-0948572, EP-A-0882099, U.S. Pat. Nos. 5,958,125, 6,139,613), coated or uncoated SiO₂ spheres (for example known from EP-A-0803550, EP-A-1063265, JP-A-11322324), EP-A-0803550, EP-A-1063265, JP-A-11322324). Particularly preferred are mica, SiO₂ flakes, Al₂O₃ flakes, TiO₂ flakes, Fe₂O₃ flakes, and glass flakes.

In said aspect of the present invention the particles are flakes, comprising

(a) a transparent substrate having a low index of refraction, especially natural, or synthetic mica, another layered silicate, glass (there are several type of glasses labeled A, C, E and B; each comprises some specific amount of SiO₂, Al₂O₃, CaO, MgO, B₂O₃, Na₂+K₂O, ZnO and FeO/Fe₂O₃; the preferred glass is the one with a softening point>600° C. even if the relative concentration of the various component has to be modified), Al₂O₃, SiO_{z}, especially SiO₂, SiO₂/SiOₓ/SiO₂ (0.03≦x≦0.95), SiO_{1.40-2.0}/SiO_{0.70-0.99}/SiO_{1.40-2.0}, or Si/SiO_{z} with 0.70≦z≦2.0, especially 1.40≦z≦2.0, and

(b) a layer of a metal oxide of high refractive index on the substrate, such as ZrO₂, Fe₂O₃, or TiO₂; and optionally further layers, or

(a) a transparent substrate having a low index of refraction, especially natural, or synthetic mica, another layered silicate, glass, Al₂O₃, SiO_{z}, especially SiO₂, SiO₂/SiOₓ/SiO₂ (0.03≦x≦0.95), SiO_{1.40-2.0}/SiO_{0.70-0.99}/SiO_{1.40-2.0}, or Si/SiO_{z} with 0.70≦z≦2.0, especially 1.40≦z≦2.0, and

(b) a reflecting layer, especially a reflecting metal layer, or a semitransparent layer, especially a semitransparent metal layer, and optionally further layers.

The color shade of the pigment flake can be varied within broad limits by selecting different covering amounts or layer thicknesses resulting there from. The fine tuning for a certain color shade can be achieved beyond the pure choice of amount by approaching the desired color under visual or measurement technology control.

Various coating processes can be utilized in forming coating layers before and/or after plasma treatment. Suitable methods for forming the coating layer include vacuum vapor deposition, sol-gel hydrolysis, CVD in a fluidized bed (U.S. Pat. No. 5,364,467 and U.S. Pat. No. 5,763,086), and electrochemical deposition. Another depositing method is the plasma enhanced chemical vapor deposition (PECVD) where the chemical species are activated by a plasma. Such a method is disclosed in detail in WO02/31058. Preferred are the wet chemical coating methods developed for the production of pearlescent pigments which are described, for example, in DE-A-14 67 468, DE-A-19 59 988, DE-A-20 09 566, DE-A-22 14 545, DE-A-22 15 191, DE-A-22 44 298, DE-A-23 13 331, DE-A-25 22 572, DE-A-31 37 808, DE-A-31 37 809, DE-A-31 51 343, DE-A-31 51 354, DE-A-31 51 355, DE-A-32 11 602 and DE-A-32 35 017, DE 195 99 88, WO 93/08237, and WO 98/53001 and wet chemical coating methods using microwave radiation which are described, for example, in WO2004111298 and WO2004113455.

In principle, the plane parallel pigments can comprise in addition to the substrate materials having a “low” index of refraction, which is defined herein as an index of refraction of about 1.65 or less, or can have a “high” index of refraction, which is defined herein as an index of refraction of greater than about 1.65. Various (dielectric) materials that can be utilized include inorganic materials such as metal oxides, metal fluorides, metal sulfides, metal nitrides, metal carbides, combinations thereof, and the like, as well as organic dielectric materials. These materials are readily available and easily applied by physical or chemical vapor deposition processes, especially wet-chemical processes.

Nonlimiting examples of suitable low index dielectric materials that can be used include silicon dioxide (SiO₂), aluminum oxide (Al₂O₃), and metal fluorides such as magnesium fluoride (MgF₂), aluminum fluoride (AlF₃), cerium fluoride (CeF₃), lanthanum fluoride (LaF₃), sodium aluminum fluorides (e.g., Na₃AlF₆ or NaAl₃F₁₄), neodymium fluoride (NdF₃), samarium fluoride (SmF₃), barium fluoride (BaF₂), calcium fluoride (CaF₂), lithium fluoride (LiF), combinations thereof, or any other low index material having an index of refraction of about 1.65 or less. For example, organic monomers and polymers can be utilized as low index materials, including dienes or alkenes such as acrylates (e.g., methacrylate), polymers of perfluoroalkenes, polytetrafluoroethylene (TEFLON), polymers of fluorinated ethylene propylene (FEP), parylene, p-xylene, combinations thereof, and the like. Additionally, the foregoing materials include evaporated, condensed and cross-linked transparent acrylate layers, which may be deposited by methods described in U.S. Pat. No. 5,877,895, the disclosure of which is incorporated herein by reference. Nonlimiting examples of suitable high index dielectric materials are given below.

Suitable metals for the semi-transparent metal layer are, for example, Cr, Ti, Mo, W, Al, Cu, Ag, Au, or Ni. Preferred pigments have the following layer structure: transparent substrate+metal+SiO₂+metal oxide having a high index of refraction.

In an especially preferred embodiment, the pigment on the basis of the transparent substrate, comprises a further layer of a dielectric material having a “high” refractive index, that is to say a refractive index greater than about 1.65, preferably greater than about 2.0, most preferred greater than about 2.2, which is applied to the entire surface of the substrate. Examples of such a dielectric material are zinc sulfide (ZnS), zinc oxide (ZnO), zirconium oxide (ZrO₂), titanium dioxide (TiO₂), carbon, indium oxide (In₂O₃), indium tin oxide (ITO), tantalum pentoxide (Ta₂O₅), chromium oxide (Cr₂O₃), cerium oxide (CeO₂), yttrium oxide (Y₂O₃), europium oxide (Eu₂O₃), iron oxides such as iron(II)/iron(III) oxide (Fe₃O₄) and iron(III) oxide (Fe₂O₃), hafnium nitride (HfN), hafnium carbide (HfC), hafnium oxide (HfO₂), lanthanum oxide (La₂O₃), magnesium oxide (MgO), neodymium oxide (Nd₂O₃), praseodymium oxide (Pr₆O₁₁), samarium oxide (Sm₂O₃), antimony trioxide (Sb₂O₃), silicon monoxides (SiO), selenium trioxide (Se₂O₃), tin oxide (SnO₂), tungsten trioxide (WO₃) or combinations thereof. The dielectric material is preferably a metal oxide, it being possible for the metal oxide to be a single oxide or a mixture of oxides, with or without absorbing properties, for example TiO₂, ZrO₂, Fe₂O₃, Fe₃O₄, Cr₂O₃ or ZnO, with TiO₂ being especially preferred.

It is possible to obtain pigments that are more intense in colour and more transparent by applying, on top of the TiO₂ layer, a metal oxide of low refractive index, such as SiO₂, Al₂O₃, AlOOH, B₂O₃ or a mixture thereof, preferably SiO₂, and applying a further TiO₂ layer on top of the latter layer (EP-A-892832, EP-A-753545, WO93/08237, WO98/53011, WO9812266, WO9838254, WO99/20695, WO00/42111, and EP-A-1213330).

Flakes having the following layer structure are especially preferred:

| | | | |
|---|---|---|---|
| TRASUB | TiO₂ | | |
| TRASUB | TiO_{suboxides} | | |
| TRASUB | TiO₂ | TiN | |
| TRASUB | TiO₂ | SiO₂ | |
| TRASUB | TiO₂ | TiO_{suboxides} | |
| TRASUB | TiO₂ | TiON | TiN |
| TRASUB | TiO₂ | SiO₂ | TiO₂ |
| TRASUB | TiO₂ | SiO₂ | SiO_{suboxides} |
| TRASUB | TiO₂ | SiO₂ | Fe₂O₃ |
| TRASUB | TiO₂ | SiO₂ | TiO₂/Fe₂O₃ |
| TRASUB | TiO₂ | SiO₂ | (Sn,Sb)O₂ |
| TRASUB | (Sn,Sb)O₂ | SiO₂ | TiO₂ |
| TRASUB | Fe₂O₃ | SiO₂ | (Sn,Sb)O₂ |
| TRASUB | TiO₂/Fe₂O₃ | SiO₂ | TiO₂/Fe₂O₃ |
| TRASUB | Cr₂O₃ | SiO₂ | TiO₂ |
| TRASUB | Fe₂O₃ | SiO₂ | TiO₂ |
| TRASUB | TiO_{suboxides} | SiO₂ | TiO_{suboxides} |
| TRASUB | TiO₂ | SiO₂ | TiO₂ + SiO₂ + TiO₂ |
| TRASUB | TiO₂ + SiO₂ + TiO₂ | SiO₂ | TiO₂ + SiO₂ + TiO₂ |
| TRASUB | TiO₂ | Al₂O₃ | TiO₂ |
| TRASUB | Fe₂TiO₅ | SiO₂ | TiO₂ |
| TRASUB | TiO₂ | SiO₂ | Fe₂TiO₅/TiO₂ |
| TRASUB | TiO₂ | SiO₂ | MoS₂ |
| TRASUB | TiO₂ | SiO₂ | Cr₂O₃ |
| TRASUB | TiO₂ | SiO₂ | TiO₂ + SiO₂ + TiO₂ + |
| | | | Prussian Blue |
| TRASUB | TiO₂ | STL | |

wherein TRASUB is a transparent substrate having a low index of refraction, especially natural, or synthetic mica, another layered silicate, glass, Al₂O₃, SiO_{z}, especially SiO₂, SiO₂/SiOₓ/SiO₂ (0.03≦x≦0.95), SiO_{1.40-2.0}/SiO_{0.70-0.99}/SiO_{1.40}-2.0, or Si/SiO_{z} with 0.70≦z≦2.0, especially 1.40≦z≦2.0, and
STL is a semi-transparent layer, such as, for example, semi-transparent metal layer of Cu, Ag, Cr, or Sn, or a semitransparent carbon, or TiO_{suboxides} or SiO_{suboxides} layer.

SiO_{suboxides} refers to oxidation states of Si<4.

If the pigments have a multilayer structure, it is preferred that the pigments are treated according to the process of the present invention one time after the deposition of all layers.

In another aspect the particles are titanium dioxide-containing pigments. Such a pigment has a multilayer structure, where, on a core of platelet shaped titanium dioxide, there follows a layer of another metal oxide or metal oxide hydrate. Examples of other metal oxides or metal oxide hydrates which are applied to the titanium dioxide are Fe₂O₃, Fe₃O₄, FeOOH, Cr₂O₃, CuO, Ce₂O₃, Al₂O₃, SiO₂, BiVO₄, NiTiO₃, CoTiO₃ and also antimony-doped, fluorine-doped or indium-doped tin oxide. In a particular embodiment of the novel pigment, on the 1^{st} layer of another metal oxide or metal oxide hydrate is additionally present a 2^{nd} layer of a further metal oxide or metal oxide hydrate. This further metal oxide or metal oxide hydrate is aluminium oxide or aluminium oxide hydrate, silicon dioxide or silicon dioxide hydrate, Fe₂O₃, Fe₃O₄, FeOOH, TiO₂, ZrO₂, Cr₂O₃ as well as antimony-doped, fluorine-doped or indium-doped tin oxide, wherein the metal oxide of the first layer is different from that of the second layer.

These titanium dioxide platelets have a thickness of between 10 nm and 500 nm, preferably between 40 and 150 nm. The extent in the two other dimensions is between 2 and 200 μm and in particular between 5 and 50 μm.

The layer of another metal oxide which is applied to the titanium dioxide platelets has a thickness of 5 to 300 nm, preferably between 5 and 150 nm.

The titanium dioxide platelets are, for example, available according to a process described in WO98/53010, WO2004113455 and WO2004111298.

In another aspect the effect pigments are based on multiply coated iron oxide platelets comprise at least one layer packet comprising

b) a colorless coating having a refractive index n<1.8, and

c) a colorless coating having a refractive index>2.0.

The size of the iron oxide platelets is not critical per se and can be adapted to the particular application intended. In general, the platelets have mean largest diameters from about 1 to 50 μm, preferably from 5 to 20 μm. The thickness of the platelets is generally within the range from 10 to 500 nm.

The colorless low refractive coating (b) has a refractive index n≦1.8, preferably n≦1.6. Examples of such materials have been given above. Particularly suitable materials include for example metal oxides and metal oxide hydrates such as silicon oxide, silicon oxide hydrate, aluminum oxide, aluminum oxide hydrate and mixtures thereof, preference being given to silicon oxide (hydrate).

The geometric layer thickness of the coating (b) is generally within the range from 50 to 800 nm, preferably within the range from 100 to 600 nm. Since the layer (b) essentially determines the interference colors of the pigments, it has a minimum layer thickness of about 200 nm for luster pigments which have just one layer packet (b)+(c) and which exhibit a particularly pronounced color play and hence are also preferred. If a plurality (e.g., 2, 3 or 4) of layer packets (b)+(c) are present, the layer thickness of (b) is preferably within the range from 50 to 200 nm.

The colorless high refractive coating (c) has a refractive index n>2.0, especially n>2.4. Examples of such materials have been given above. Particularly suitable layer materials(b) include not only metal sulfides such as zinc sulfide but especially metal oxides and metal oxide hydrates, for example titanium dioxide, titanium oxide hydrate, zirconium dioxide, zirconium oxide hydrate, tin dioxide, tin oxide hydrate, zinc oxide, zinc oxide hydrate and mixtures thereof, preference being given to titanium dioxide and titanium oxide hydrate and their mixtures with up to about 5% by weight of the other metal oxides, especially tin dioxide.

The coating (c) preferably has a smaller layer thickness than the coating (b). Preferred geometric layer thicknesses for coating (c) range from about 5 to 50 nm, especially from 10 to 40 nm.

The coating (c), which is preferred according to the present invention, consists essentially of titanium dioxide.

Further effect pigments which can be treated by the process of the present invention comprise (a) a metallic platelet-shaped substrate such as titanium, silver, aluminum, copper, chromium, iron, germanium, molybdenum, tantalum, or nickel, and (b) a layer of a metal oxide of low refractive index, such as SiO₂, SiO_{z} or Al₂O₃, or of high refractive index, such as ZrO₂, TiO_{suboxides} or TiO₂, on the substrate, wherein 0.70≦z≦2.0, preferably 1.0≦z≦2.0, most preferably 1.4≦z≦2.0.

Flakes having a metal core followed by a layer of metal oxide and a semi-transparent coating.

| | | | |
|---|---|---|---|
| METAL | TiO₂ | | |
| METAL | TiO_{suboxides} | | |
| METAL | TiO₂ | TiN | |
| METAL | TiO₂ | SiO₂ | |
| METAL | TiO₂ | TiO_{suboxides} | |
| METAL | TiO₂ | TiON | TiN |
| METAL | TiO₂ | TiO_{suboxides} | C |
| METAL | SiO₂ | SiO_{suboxided} | |
| METAL | SiO₂ | TiO₂ | TiO_{suboxides} |

METAL is any reflecting layer preferably a metal reflecting layer such as titanium, silver, aluminum, copper, chromium, iron, germanium, molybdenum, tantalum, or nickel. Most preferably the flakes are aluminum.

Preferred are pigments on basis of SiO_{z} coated aluminum flake are available by a process described in WO04/052999, or SiO₂ coated aluminum flakes obtained by the process described in WO04/052999. Such pigments have preferably the following layer structure: C/X/Al/X/C, Al/X/Al/X/Al, C (5-40 nm)/X (100-600 nm)/Al (50-100 nm)/X (100-600 nm)/C (5-40 nm), MoS₂/X/Al/X/MoS₂, Fe₂O₃/X/Al/X/Fe₂O₃, wherein X is SiO₂, or SiO_{z}, wherein 0.70≦z≦2.0, preferably 1.0≦z≦2.0, most preferably 1.4≦z≦2.0.

Also preferred are pigment on the basis of SiO₂ or TiO₂ coated aluminum flakes. Such pigments have preferably the following layer structure of C/X/AL/X/C. C is any semi-transparent (or semi-opaque) material, such as for example chromium, TiO_{suboxides} or SiO_{z} wherein X is SiO₂ or TiO₂, wherein 0.70≦z≦2.0, preferably 1.0≦z≦2.0, most preferably 1.4≦z≦2.0.

For example, Alternative C/X/Al/X/C effect pigments are TiO_{suboxides}/SiO₂/Al/SiO₂/TiO_{suboxides}, SiO_{suboxides}/SiO₂/Al/SiO₂/SiO_{suboxides,} TiO_{suboxides}/TiO₂/SiO₂/Al/SiO₂/TiO₂/TiO_{suboxides}.

In addition, the process of the present invention can be used to convert the anatase form of TiO₂ to the rutile form of TiO₂. The process may catalysed by adding small amounts of SnO₂. For example, as described in WO 93/08237, tin dioxide can be deposited before titanium dioxide precipitation. The same effect is obtained if a small concentration of Fe and one or more of Zn, Ca and Mg ions are introduced into the coating prior to the start of the precipitation of hydrous titanium dioxide (U.S. Pat. No. 6,056,815 and U.S. Pat. No. 5,433,779).

It is well known that TiO₂ coatings on bare mica exhibit the anatase crystalline phase, regardless of the calcinations temperature applied. Anatase is not the preferred crystalline form for effect pigments due to its lower index of refraction (anatase=2.3, rutile=2.7) and enhanced photocatalytic activity. A common approach to induce crystallization to the rutile phase is to first deposit a thin layer of tin oxide to the mica substrate via wet chemistry. Tin oxide has a cassiterite structure which is closely similar to the rutile phase. Subsequent deposition of TiO₂ on top of the tin oxide layer will template the growth of the rutile phase rather than anatase.

Surprisingly, the present inventors have discovered that it is possible to convert the kinetically stable anatase phase to the thermodynamically stable rutile form without a templating layer of tin oxide by treating the anatase coated precusor in a plasma torch. Thus the process of the invention offers a tin free rutile coated flake.

Tin oxide free rutile coated flakes are especially advantageous in applications such as cosmetics and personal care applications where tin oxide content is discouraged in certain countries such as Japan.

It has also been discovered that varying plasma conditions (reducing or oxidizing) alters the color shade of the TiO₂ pigment essentially by controlling the oxygen stoichiometry. The resulting pigment displays a silvery or golden metallic effect.

Accordingly, the present invention also relates to a process for the treatment of particles, comprising

(A) providing platelet-like particles, comprising

(a) a transparent substrate having a low index of refraction, especially natural, or synthetic mica, another layered silicate, glass, Al₂O₃, SiO_{z}, especially SiO₂, SiO₂/SiOₓ/SiO₂ (0.03≦x≦0.95), SiO_{1.40-2.0}/SiO_{0.70-0.99}/SiO_{1.40-2.0} or Si/SiO_{z} with 0.70≦z≦2.0, especially 1.40≦z≦2.0,
(b) a layer of titanium oxide in the anatase modification on the substrate, and (c) optionally a tin oxide layer between the substrate (a) and the layer (b); or platelet-like titanium oxide particles in the anatase modification, optionally containing tin oxide,
   (B) entraining said particles in a stream of gas for transport to a plasma torch;
   (C) creating a plasma in said stream of gas to heat the outer surface of the particles;
   (D) permitting said particles to cool so as to form solid particles; and
   (E) collecting platelet-like particles, comprising
(a) a transparent substrate having a low index of refraction, especially natural, or synthetic mica, another layered silicate, glass, Al₂O₃, SiO_{z}, especially SiO₂, SiO₂/SiOₓ/SiO₂ (0.03≦x≦0.95), SiO_{1.40-2.0}/SiO_{0.70-0.99}/SiO_{1.40}-2.0, or Si/SiO_{z} with 0.70≦z≦2.0, especially 1.40≦z≦2.0,
(b) a layer of titanium oxide in the rutile modification on the substrate, and optionally a
(c) tin oxide layer between the substrate (a) and the layer (b); platelet-like titanium oxide particles in the rutile modification, optionally containing tin oxide.

The rutile modified platelet-like particles above can be further modified by deposition with subsequent coatings of TiO₂. For example, a second coating of TiO₂ can be deposited over the rutile modified layer by wet chemical deposition. Upon calcination the second TiO₂ coating converts to the rutile phase. This subsequent coating(s) may give rutile coatings of various thicknesses all without templating with tin oxide.

The process is preferably used for the afore-mentioned flakes having the following layer structure: TRASUB/(SnO₂)TiO₂, wherein TRASUB is a transparent substrate, wherein the SnO₂ is optional. The transparent substrates are especially glass flakes having thicknesses below 500 nm, especially below 350 nm and standard deviation of thickness variations as low as 30 percent of the mean thickness, the production of which is described in WO2004/056716.

It is known that titanium dioxide particles present as the pigment component in a surface-coating composition cause oxidative decomposition of the polymer on exposure to ultra-violet rays and moisture, known as whitening.

In order to suppress this effect of titanium dioxide, particles, especially flakes, comprising (a) a transparent substrate having a low index of refraction, especially natural, or synthetic mica, another layered silicate, glass, Al₂O₃, SiO_{z}, especially SiO₂, SiO₂/SiOₓ/SiO₂ (0.03≦x≦0.95), SiO_{1.40-2.0}/SiO_{0.70-0.99}/SiO_{1.40-2.0}, or Si/SiO_{z} with 0.70≦z≦2.0, especially 1.40≦z≦2.0, and

(b) a titanium dioxide layer,

(c) a layer of hydrous aluminum oxide, a layer of hydrated zirconium oxide, a top layer comprising hydrated zirconium oxide obtained by hydrolysis in the presence of a hypophosphite, and a hydrated metal oxide, or a combination of hydrated cerium and aluminum oxides, are treated by the process of the present invention, a layer (topcoat) which contains a polysiloxane and a rare earth metal compound

The coating of a metal oxide-coated mica pigment with a hydrous aluminum oxide is known. It is described, for example, in U.S. Pat. No. 5,091,011, the disclosure of which is incorporated herein by reference. Briefly, the pigment is dispersed by stirring in water and then an aluminum compound such as aluminum chloride, aluminum sulfate or aluminum potassium sulfate, and a neutralizing agent such as sodium hydroxide, potassium hydroxide, ammonia or urea, are added simultaneously as aqueous solutions. The resulting hydrolysis causes the hydrous oxide to deposit on the substrate. The aluminum compound must be added slowly enough to permit the formation of a smooth, continuous layer on the platelets and the rate should fall within the range of about 0.03 to 0.1 mg Al per minute per gram of pigment, preferably about 0.005 to 0.07 mg Al/min/g pigment. A quantity of aluminum compound solution is used so as to produce a hydrous aluminum oxide coating containing about 0.05 to 1.2% aluminum, preferably about 0.1 to 0.8% aluminum, based on the total weight of the pigment. After deposition of the coating, the product can be filtered, washed with water and dried.

The coating of the titanium dioxide- or iron oxide-coated mica pearlescent pigment with a coating consisting essentially of a combination of hydrated cerium and aluminum oxides is also per se known. It is described, for instance, in U.S. Pat. No. 5,423,912, the disclosure of which is incorporated herein by reference.

The aluminum- or aluminum-cerium-treated metal oxide-coated mica pearlescent pigment can optionally be treated with a hydrolyzed silane coupling agent or a mixture of such agents. These, as known, are compounds which act as an interface between an organic material and an inorganic material to enhance the affinity between the two. Thus, the silane coupling agents generally have both an organo functional group and a silicon functional group bonded either directly or indirectly to silicon.

Examples of silane coupling agents are γ-(2-aminoethyl)aminopropyl trimethoxy silane, aminopropyl trimethoxy silane, γ-aminopropyl triethoxy silane, γ-(2-aminoethyl)aminopropyl methyl dimethoxy silane, γ-methacyryloxypropyl methyl trimethoxy silane, γ-methacyryloxypropyl trimethoxy silane, γ-glycidoxypropyl trimethoxy silane, γ-mercaptopropyl trimethoxy silane, vinyltriacetoxysilane, γ-chloropropyl trimethoxy silane, vinyltrimethoxy silane, octadecyidimethyl-[3-(trimethoxysilyl)-propyl] ammonium chloride, γ-mercaptopropyl-methyl-dimethoxy silane, methyltrichloro silane, dimethyl-dichlorosilane, trimethylchlorosilane, γ-isocyanatopropyl triethoxy silane and the like.

Pearlescent pigments having a hydrated zirconium oxide coating on the titanium dioxide base pigment are described EP-A-0 268 918, this coating being obtained by hydrolysis of a zirconium salt in the presence of a hypophosphite.

Pearlescent pigments having, on the titanium dioxide base pigment, a top layer comprising hydrated zirconium oxide obtained by hydrolysis in the presence of a hypophosphite, and a hydrated metal oxide, are described in EP-A-0 342 533. The metal oxide can be cobalt oxide, manganese oxide or cerium oxide.

Mica flakes coated with metal oxides, characterized in that on top of the coat of metal oxide the pigments possess a topcoat which contains a polysiloxane and a rare earth metal compound are described in U.S. Pat. No. 4,544,415. The rare earth metal is preferably cerium. In addition, the layer can comprise a compatible zinc or aluminum compound or both, or a silicate.

The above described layer are especially used to provide stability for titanium dioxide-coated mica platelets.

In a further aspect the process of the present invention is used to modify platelet-like mica particles. Accordingly, the present invention provides a process for the treatment of particles, comprising

(A) providing layered silicate flakes, especially platelet-like mica particles,

(B) entraining said particles in a stream of gas for transport to a plasma torch;

(C) creating a plasma in said stream of gas to heat the outer surface of the particles;

(D) permitting said particles to cool so as to form solid particles; and

(E) collecting layered silicate flakes, especially platelet-like mica particles.

The process of the present can provide layered silicate flakes, especially platelet-like mica particles having a smaller average thickness and/or smoother surface as the starting material. Examples of layered silicate flakes are, for example, mica, montmorillonite, saponite etc.

Said aspect is explained in more detail on the basis of platelet-like mica particles, but is not limited thereto.

The platelet-like mica particles are preferably injected as a slurry (e.g. aqueous) into the plasma reactor. This slurry is atomized at the tip of the injection probe.

The platelet-like mica particles can be of natural, or synthetic origin. Natural or synthetic are both preferred, depending on the availability.

The synthetic mica used in the present invention is expressed by the following general formula:
X_{0.5-1}Y₂₋₃Z₄O₁₀(F₅OH)₂ (1)
where X is an interlayer ion occupying coordination number of 12 and represents K⁺, Na⁺, Li⁺, Rb⁺, Cs⁺, Tl⁺, Ca²⁺, Sr²⁺ and Ba²⁺.

Y is an octahedral ion occupying coordination number of 6 and represents Mg²⁺, Fe²⁺, Co²⁺, Ni²⁺, Mn²⁺, Li⁺, Ti²⁺, Zn²⁺, Cu²⁺, Al³⁺, Ti³⁺, Cr³⁺, Fe³⁺ and Mn³⁺.

Z is a tetrahedral ion occupying coordination number of 4 and represents Si⁴⁺, Al³⁺, B³⁺, Fe³⁺, Mn³⁺, Be²⁺, Zn²⁺ and Ge⁴⁺.

As the synthetic mica used in the present invention, fluorine mica such as fluoro phlogopite, fluoro tetrasilicic mica, fluoro taeniolite and isomorphous substituent of these substances can be used preferably. Among the above synthetic mica, it may be used a synthetic mica, which contains at least one type selected from Ti, Zn, Na, B, Li, Ca, Ge, Sr and Zr by 0.01 to 5%.

It is preferable that flaky (synthetic) mica particles having diameter of plane direction of 3 to 100 μm and thickness of 0.05 to 1 μm are used as starting material in the present invention. The synthetic mica used in the present invention has refractive index of not more than 1.58. It is preferable that aspect ratio of the synthetic mica is 60 or more. By the use of the process of the present invention, it is possible to obtain flaky (synthetic) mica particles having diameter of plane direction of 5 to 200 μm and an average thickness of 250 nm or less, with a standard deviation of the thickness of less than 40% of the average thickness and a smoothened surface. It is preferable that aspect ratio of the synthetic mica is 60 or more.

The use of this synthetic mica treated by the process of the present invention makes it possible to increase the luminance of the pearlescent pigment, to provide sharp and bright color and to exclude blurred complementary colors.

The process of the present invention provides new products. Accordingly, the present invention is also directed to products, obtainable by the process of the present invention.

As one particular embodiment of the invention, the products obtainable by the process of the invention are directed to pigments. Because it is possible to obtain special colors and other special effects by the process of the invention, the obtainable pigments may be incorporated into coatings, plastics, printing inks, cosmetics and personal care products.

The plasma treated particles are highly suitable for coloring high molecular weight materials which can be further processed to fibers, cast and molded articles or coating compositions such as solvent or water based coatings, which are for example conventionally employed in the automobile industry.

Thus, the high molecular weight organic material is preferably an industrial paint, automotive paint, or molded article.

Suitable high molecular weight organic materials include thermoplastics, thermoset plastics or elastomers, natural resins or casein for example, cellulose ethers; cellulose esters such as ethyl cellulose; linear or crosslinked polyurethanes; linear, crosslinked or unsaturated polyesters; polycarbonates; polyolefins such as polyethylene, polypropylene, polybutylene or poly-4-methylpent-1-ene; polystyrene; polysulfones; polyamides; polycycloamides; polyimides; polyethers; polyether ketones such as polyphenylene oxides; and also poly-p-xylene; polyvinyl halides such as polyvinyl chloride, polyvinylidene chloride, polyvinylidene fluoride or polytetrafluoroethylene; acrylic polymers such as polyacrylates, polymethacrylates or polyacrylonitrile; rubber; silicone polymers; phenol/formaldehyde resins; melamine/formaldehyde resins; urea/formaldehyde resins; epoxy resins; styrene butadiene rubber; acrylonitrile-butadiene rubber or chloroprene rubber; singly or in mixtures.

High molecular weight for purposes of the invention means an average molecular weight of from about 10² to about 10⁶ g/mole.

Thus coatings, plastics, paints, printing inks, ceramics or glasses incorporating particles obtainable by the process of the invention and uses thereof are embodied by the invention.

The plasma treated particles may also be incorporated as a single components or in mixture with other compounds. In particular for skin-care products, bath and shower additives, preparations containing fragrances and odoriferous substances, hair-care products, deodorizing and antiperspirant preparations, decorative preparations, light protection formulations and preparations containing active ingredients and uses thereof are envisioned.

Skin-care products are, in particular, body oils, body lotions, body gels, treatment creams, skin protection ointments, shaving preparations, such as shaving foams or gels, skin powders, such as baby powder, moisturizing gels, moisturizing sprays, revitalizing body sprays, cellulite gels and peeling preparations.

Suitable bath and shower additives are shower gels, bath-salts, bubble baths and soaps.

Preparations containing fragrances and odoriferous substances are in particular scents, per-fumes, toilet waters and shaving lotions (aftershave preparations).

Suitable hair-care products are, for example, shampoos for humans and animals, in particular dogs, hair conditioners, products for styling and treating hair, perming agents, hair sprays and lacquers, hair gels, hair fixatives and hair dyeing or bleaching agents.

Suitable decorative preparations are in particular lipsticks, nail varnishes, eye shadows, mascaras, dry and moist make-up, rouge, powders, depilatory agents and suntan lotions.

Suitable cosmetic formulations containing active ingredients are in particular hormone preparations, vitamin preparations and vegetable extract preparations.

The mentioned body-care products may be in the form of creams, ointments, pastes, foams, gels, lotions, powders, make-ups, sprays, sticks or aerosols.

The present invention therefore also relates to a body-care product comprising at least one plasma treated particle obtainable by the process of the invention.

The treated particles are present in the body care and household products in a concentration of about 0.0001% to about 25%, based on the total formulation, preferably from about 0.001% to about 15%, and most preferably from about 0.05% to about 10%.

The present pigments are particularly suitable for coloration of cosmetic and body care products, in particular:
skin-care preparations, e.g. skin-washing and cleansing preparations in the form of tablet-form or liquid soaps, soapless detergents or washing pastes,
bath preparations, e.g. liquid (foam baths, milks, shower preparations) or solid bath preparations, e.g. bath cubes and bath salts;
skin-care preparations, e.g. skin emulsions, multi-emulsions or skin oils; body oils, body lotions, body gels; skin protection ointments;
cosmetic personal care preparations, e.g. facial make-up in the form of day creams or powder creams, face powder (loose or pressed), rouge or cream make-up, eye-care preparations, e.g. eyeshadow preparations, mascara, eyeliner, eye creams or eye-fix creams; lip-care preparations, e.g. lipsticks, lip gloss, lip contour pencils, nail-care preparations, such as nail varnish, nail varnish removers, nail hardeners or cuticle removers;
foot-care preparations, e.g. foot baths, foot powders, foot creams or foot balsams, special deodorants and antiperspirants or callus-removing preparations;
light-protective preparations, such as sun milks, lotions, creams or oils, sunblocks or tropicals, pre-tanning preparations or after-sun preparations;
skin-tanning preparations, e.g. self-tanning creams;
depigmenting preparations, e.g. preparations for bleaching the skin or skin-lightening preparations;
insect-repellents, e.g. insect-repellent oils, lotions, sprays or sticks;
deodorants, such as deodorant sprays, pump-action sprays, deodorant gels, sticks or roll-ons;
antiperspirants, e.g. antiperspirant sticks, creams or roll-ons;
preparations for cleansing and caring for blemished skin, e.g. synthetic detergents (solid or liquid), peeling or scrub preparations or peeling masks;
hair-removal preparations in chemical form (depilation), e.g. hair-removing powders, liquid hair-removing preparations, cream- or paste-form hair-removing preparations, hair-removing preparations in gel form or aerosol foams;
shaving preparations, e.g. shaving soap, foaming shaving creams, non-foaming shaving creams, foams and gels, preshave preparations for dry shaving, aftershaves or aftershave lotions;
fragrance preparations, e.g. fragrances and odoriferous substances containing preparations (scents, eau de Cologne, eau de toilette, eau de parfum, parfum de toilette, perfume), perfume oils or perfume creams;
cosmetic hair-treatment preparations, e.g. hair-washing preparations in the form of shampoos and conditioners, hair-care preparations, e.g. pretreatment preparations, hair tonics, styling creams, styling gels, pomades, hair rinses, treatment packs, intensive hair treatments, hair-structuring preparations, e.g. hair-waving preparations for permanent waves (hot wave, mild wave, cold wave), hair-straightening preparations, liquid hair-setting preparations, hair foams, hairsprays, bleaching preparations, e.g. hydrogen peroxide solutions, lightening shampoos, bleaching creams, bleaching powders, bleaching pastes or oils, temporary, semi-permanent or permanent hair colourants, preparations containing self-oxidising dyes, or natural hair colourants, such as henna or camomile;
decorative preparations, in particular lipsticks, nail varnishes, eye shadows, mascaras, dry and moist make-up, rouge, powders, depilatory agents and suntan lotions
   cosmetic formulations containing active ingredients, in particular hormone preparations, vitamin preparations, vegetable extract preparations and antibacterial preparations.
      Presentation Forms

The final formulations listed may exist in a wide variety of presentation forms, for example:
in the form of liquid preparations as a W/O, O/W, O/W/O, W/O/W or PIT emulsion and all kinds of microemulsions,
in the form of a gel,
in the form of an oil, a cream, milk or lotion,
in the form of a stick,
in the form of a spray (spray with propellent gas or pump-action spray) or an aerosol,
in the form of a foam, or
in the form of a paste.

Examples of body care products of the present invention are listed in the Table below:

| Body care product | Ingredients |
|---|---|
| moisturizing cream | vegetable oil, emulsifier, thickener, perfume, water, |
| | stabilizers, preservatives, dyes/pigments |
| shampoo | surfactant, emulsifier, preservatives, perfume, |
| | antioxidant, UV absorbers, dyes/pigments |
| Lipstick | vegetable oils, waxes, stabilizers, dyes/pigments |
| eye shadow | Talc, Zinc Stearate, oils, stabilizers, pigments |
| Makeup | Water, thickener, oils, emulsifier, perfume, |
| | preservatives, stabilizers, pigments |

Various features and aspects of the present invention are illustrated further in the examples that follow. While these examples are presented to show one skilled in the art how to operate within the scope of this invention, they are not to serve as a limitation on the scope of the invention where such scope is only defined in the claims. Unless otherwise indicated in the following examples and elsewhere in the specification and claims, all parts and percentages are by weight, temperatures are in degrees centigrade and pressures are at or near atmospheric.

### EXAMPLES

### Example 1

A sample of Sb doped SnO₂ coated mica flakes is prepared by adding a solution of SnCl₄ and SbCl₃ in hydrochloric acid to an aqueous suspension of mica flakes at a constant pH of 1.6. The resulting material is washed with water and dried. These coated flakes are fluidized in stream of argon and fed at a rate of 40 g/minutes into a plasma reactor with a Tekna PL-70 plasma torch operated at a power of 65 kW. The sheath gas is a mixture of argon and oxygen at 166 slpm [Standard liters per Minute; Standarad Conditions for the calculation of slpm are defined as: Tn 0° C. (32° F.), Pn=1.01 bara (14.72 psia)] and the central gas is argon at 40 slpm. The operating pressure is maintained at 360 torr. The temperature within the reactor is controlled to allow for the structural solid maintenance of the flakes and only heat the outer surface of the coating. The treated flakes are collected after passing a heat exchange zone. The recovered coated flakes exhibit improved electrical conductivity.

### Example 2

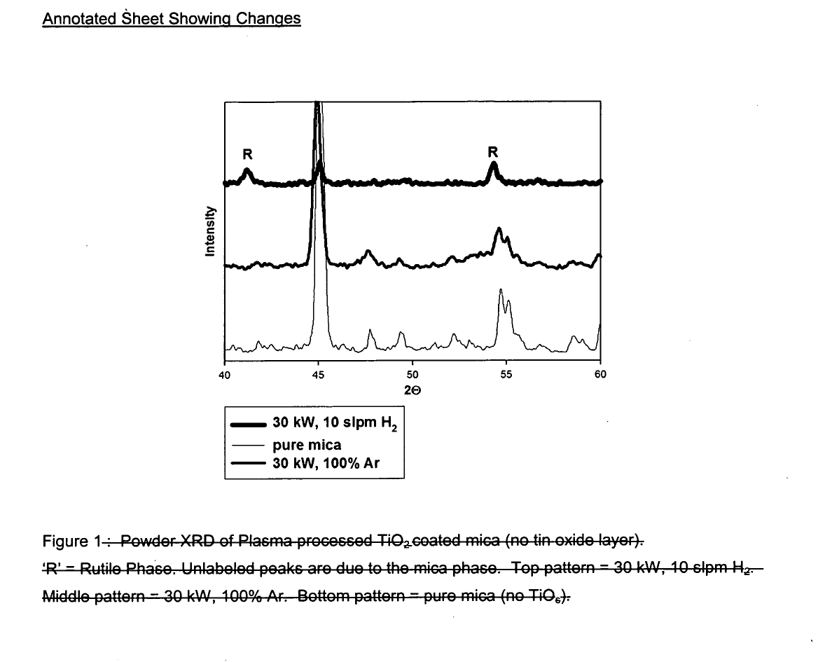

A sample of mica flakes coated with a layer of TiO₂ is made by standard wet chemical methods having the anatase phase and no rutile templating layer (ie. tin oxide). The resulting material is fluidized in a stream of argon and fed at a rate of 2.6 kg/hour into a plasma reactor with a Tekna PL-70 plasma torch operated at a power of 30 kW. The sheath gas is a mixture of 150 slpm argon and 10 slpm hydrogen [slpm=standard liters per minute; standard conditions for the calculation of slpm are defined as: Tn 0° C. (32° F.), Pn=1.01 bara (14.72 psi)] and the central gas is argon at 40 slpm. The operating pressure is maintained at slightly lower than atmospheric pressure. The temperature experienced by the TiO₂ coated mica flakes is optimized in order to only heat the outer surface of the coating while allowing for the structural solid maintenance of the flakes. The treated flakes are collected after passing a heat exchange zone. The recovered coated flakes exhibit a TiO₂ layer with the rutile crystal modification as characterized by powder XRD and Raman spectroscopy. See FIG. 1.

### Example 3

A sample of commercially available, fully calcined mica coated with an anatase layer of TiO₂ material is also subjected to the same conditions above in the plasma reactor. The recovered coated flakes also exhibit a TiO₂ layer with rutile crystal modification as characterized by powder XRD and Raman spectroscopy.

### Example 4

A sample of commercially available, fully calcined mica coated with a rutile layer of TiO₂ on top of a tin oxide layer material is also subject to the same conditions above (example 3) in the plasma reactor. The flakes maintain the TiO₂ layer with rutile crystal as characterized by powder XRD and Raman spectroscopy. The TiO₂ may also be treated under oxidizing conditions as there is no need to induce a phase transformation of TlO₂ as in example 3. However, by varying the plasma conditions, the color shade of the pigment may be changed essentially by controlling the oxygen stoichiometry.

### Example 5

Application of Treated Flakes in PVC

0.800 g of the mica coated with tin oxide and TiO₂ layered pigment composition and treated similarity as in Example 4 is mixed with 26.6 g of a polyviynyl chloride (PVC Evipol® SH 7020, EVC GmbH, Frankfurt a.M), and 14.6 ml of a masterbatch consisting of
92.21% by weight of diisodecyl phthalate (Vestinol®, Hüls Chemie)
3.60% by weight of heat stabilisers based on barium zinc carboxylate (Irgastab® BZ561, Ciba Specialty Chemicals Inc.) and
4.19% of epoxidised Soybean oil (Rheoplast® 39, Ciba Specialty Chemicals Inc.)

After a wetting time of 30 minutes, the mixture is processed on a roll mill for 8 minutes at a roll temperature of 160° C. to a thin strong metallic aspect film.

### Example 6

Surface Effects of Plasma Treatment

Methylene Blue Test

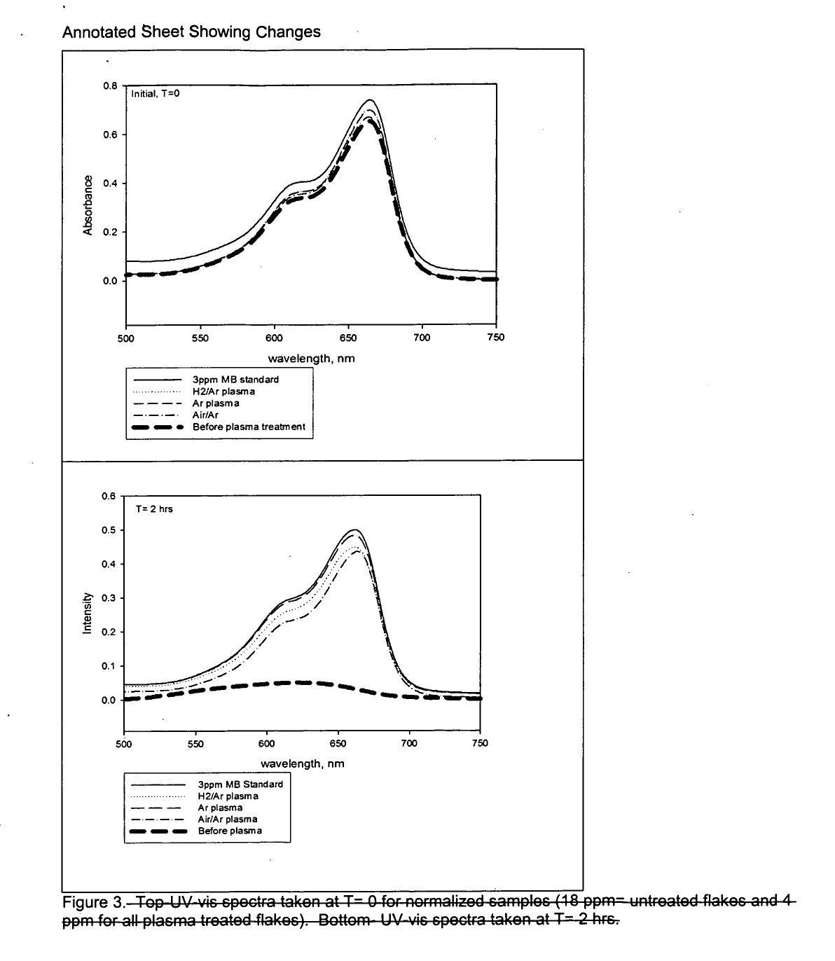

A test method to access the photocatalytic activity of plasma treated titania coated flakes versus untreated flakes (both in the rutile state) is performed using methylene blue (MB) as the probe molecule. 50 mg of titania coated flakes are added to 5 g water. Titania coated flakes treated under H₂/Ar, 100% Ar, and Air/Ar plasma conditions are compared to the flakes before plasma treatment. The first step of the MB procedure relies upon achieving an equilibrium state between MB in aqueous solution and MB adsorbed to the surface of the titania coating while stirring in the dark. Upon achieving an equilibrium state, approximately 15 ppm of MB is sorbed to the surface of the untreated powder, versus 1 ppm for the plasma treated powder. This effect is due to the reduction of surface hydroxyl groups on the titania coating which are thermally eliminated during the plasma process. The elimination of hydroxyl groups appears to occur in combination with an overall reduction of surface area and porosity of the titania coating as observed in surface electon micrograph SEM. In order to normalize the absorbance of MB in solution for all samples to a standard solution of 3 ppm MB, a total of 18 ppm of MB is added to the before plasma sample and 4 ppm is added to the plasma treated samples (see top of FIG. 3). The photodegradation of MB in solution is monitored by UV-vis spectroscopy by following the decrease in absorbance at 650 nm.

Superior photostability is observed for all plasma treated samples. This can be observed upon UV-vis analysis of the samples taken at various time intervals. As shown in the bottom FIG. 3, a 2 hr exposure of the untreated flakes results in nearly complete decomposition of the MB, whereas the plasma treated samples still retain similar MB concentration to the 3 ppm MB standard without treated pigment.

### Example 7

Surface Electron Micrographs (SEM)

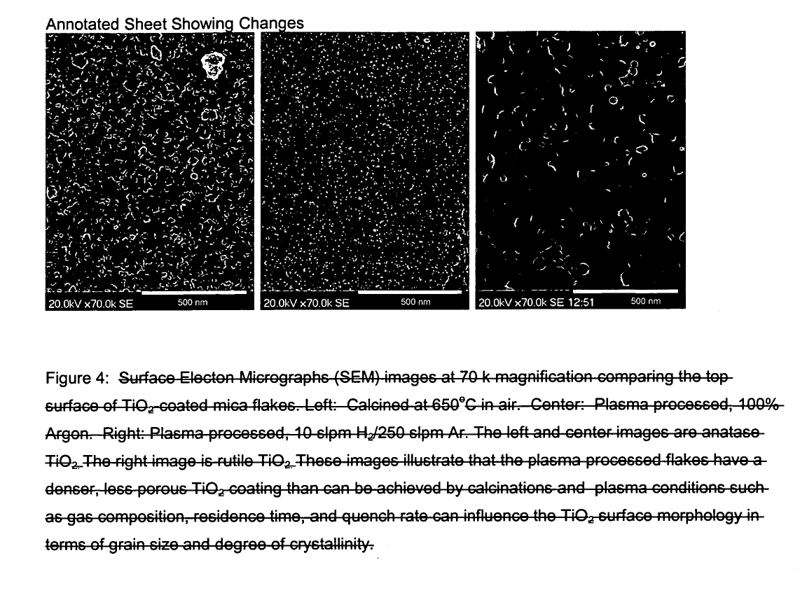

Surface Electon Micrographs (SEM) images at 70 k magnification comparing the top surface of TiO₂-coated mica flakes. See FIG. 4. Left: Calcined at 650° C. in air. Center: Plasma processed, 100% Argon. Right: Plasma processed, 10 slpm H₂/250 slpm Ar. The left and center images are anatase TiO₂. The right image is rutile TiO₂. These images illustrate that the plasma processed flakes have a denser, less porous TiO₂ coating than can be achieved by calcinations and plasma conditions such as gas composition, residence time, and quench rate can influence the TiO₂ surface morphology in terms of grain size and degree of crystallinity.

Cosmetics and Personal Care Products Containing Plasma Treated Particles

A rutile TiO₂ coated (tin oxide layer) mica pigment is plasma treated according to the invention. The untreated and treated form of this compound is tested for their properties in personal care and cosmetic formulations.

### Example 8

Nail Lacquer

The untreated and treated mica pigments, respectively, are incorporated into a no-colored nail lacquer base at 5%.

Draw downs of the resulting colored nail lacquer formulations are prepared on black and white Leneta draw-down cards.

Visual assessment shows that the plasma treated product appears much darker, exhibiting a metal-like silver-grayish shade, while the untreated TiO₂ mica coated product shows a more white, non-metallic shade.

### Example 9

Application on Skin

The treated and untreated compound, respectively, are applied directly on skin, mimicking high color load of powder compositions (e.g. eye shadows).

The color effect left on the skin reveals that the plasma treated TiO₂ appears stronger and exhibits a better coverage. The shade impression is more silver-metallic than the untreated TiO₂.

### Example 10

Application in Liquid Body Cleansing Products

The treated and untreated compound, respectively, were incorporated into an uncolored shampoo formulation at 0.05%. The treated particle created a darker, more silver-gray color than the untreated particle, which exhibited a white shade.

### Example 11

Preparation of a lipstick, non-greasy

| Ingredient | (w/w) % |
|---|---|
| Carnauba wax | 2.5 |
| Beeswax, white | 20.0 |
| Ozekerite | 10.0 |
| Lanoline, anhydrous | 5.0 |
| Cetyl alcohol | 2.0 |
| Liquid paraffin | 3.0 |
| Isopropyl Myristate | 3.0 |
| Propylene glycol recinoleate | 4.0 |
| CI Pigment Red 4 | 8.0 |
| Plasma treated Mica Pigment (TiO₂) | 2.0 |
| Stabilizer | 0.1 |
| Castor Oil | ad 100 |

### Example 12

Preparation of a lipstick, transfer resistant

| Ingredients | (w/w) % |
|---|---|
| Cyclomethicone | 41.50 |
| Isodecane | 10.00 |
| D&C Red No. 7 Al Lake | 5.00 |
| Synthetic wax | 6.00 |
| Isostearyltrimethylpropane siloxysilicate | 5.00 |
| Cetylstearate/acetylated lanolin, 90:10 | 5.00 |
| Ceresin | 4.00 |
| Paraffin | 3.00 |
| Plasma treated Mica Pigment (TiO₂) | 5.00 |
| Methylparaben | 0.30 |
| Propylparaben | 0.10 |
| Stabilizers | 0.20 |

### Example 13

Preparation of a pressed powder

| Ingredients | (w/w) % |
|---|---|
| Talc Micro Ace P-2 | 41.5 |
| Zinc Stearate | 5.0 |
| Microslip 519 (PTFE) | 4.0 |
| Nylon-12 | 4.0 |
| Sericite PHN | 10.0 |
| Ultamarine Blue | 5.0 |
| Manganese Violet | 10.0 |
| Ferric Ferrocyanide | 0.5 |
| Squalane | 5.0 |
| Plasma treated Mica Pigment (TiO₂) | 14.0 |
| Optiphen Plus | 1.0 |
| Perfume | q.s. |

### Example 14

Preparation of a Foundation cream

| Ingredients | (w/w) % |
|---|---|
| Titanium dioxide | 12.79 |
| Oleyl alcohol | 4.57 |
| Glyceryl stearate | 3.65 |
| Propylene glycol | 3.65 |
| Stearic acid | 1.83 |
| Magnesium aluminium silicate | 0.91 |
| Triethanolamine 99% | 0.91 |
| Iron Oxide Yellow | 0.64 |
| Iron Oxide Red | 0.32 |
| CI Pigment Brown 6 | 0.37 |
| Carboxymethyl cellulose | 0.10 |
| Plasma treated Mica Pigment (TiO₂) | 1.00 |
| Water | ad 100 |

### Example 15

EXAMPLE 15
Preparation of a Nail Varnish

| Ingredients | (w/w) % |
|---|---|
| Poly(1-trimethylsilylpropylene) | 0.30 |
| Nitrocellulose | 12.00 |
| Alkyd resin | 10.00 |
| Dibutyl phthalate | 4.00 |
| Camphor | 2.00 |
| Butyl acetate | 45.00 |
| Toluene | 20.00 |
| Pigment Red 57.1 | 0.70 |
| Quaternary bentonite | 1.00 |
| Plasma treated Mica Pigment (TiO₂) | 5.00 |

### Example 16

Preparation of a shampoo:

| Ingredients | (w/w) % |
|---|---|
| Water | To 100 |
| Sodium Laureth Sulfate | 15.0 |
| Cocamidopropyl Betaine | 4.0 |
| Polyquaternium-7 | 0.4 |
| Phenoxyethanol (and) Methylparaben (and) Ethylparaben | 0.5 |
| (and) Butylparaben (and) Propylparaben (and) Isobutylparaben | |
| Citric Acid | To pH 6.5 |
| Sodium Chloride | 1.0 |
| Sodium Benzotriazolyl Butylphenol Sulfonate | 0.03 |
| Plasma treated Mica Pigment (TiO₂) | 0.05 |

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

1. A process for the treatment of particles, comprising
(A) providing particles or platelet-like particles, comprising
(a) a substrate and
(b) at least one layer on the substrate;
(B) entraining said particles in a stream of gas for transport to a plasma torch;
(C) creating a plasma in said stream of gas to heat the outer surface of the particles;
(D) permitting said particles to cool; and
(E) collecting said particles.

2. The process of claim 1 wherein the layer (b) has been deposited by a wet chemical method.

3. The process of claim 1 wherein the plasma torch is an induction plasma torch.

4. The process of claim 1 wherein the layer (b) is a conductive layer including metal oxides doped with tin oxides doped with antimony, phosphorus or fluorine of 0.1-30 wt % or tin oxides doped with tellurium of 0.01-5 wt % or indium oxide system doped with 0.1-20 wt % of tin, CdSnO₃, Cd₂SnO₄, In₂TeO₆, CdIn₂O₄, CdIn₍₂₋ₓ₎ SnₓO₄ (x=0.001-0.2), Cd₂Sn_{(1-y)}Sb_{y}O₄ (y=0.001-0.1), and In₂Te_{0.98}Re_{0.02}O₆.

5. The process of claim 1 wherein the particles are flakes, comprising
(a) a transparent substrate having a low index of refraction selected from the group consisting of natural, or synthetic mica, another layered silicate, glass, Al₂O₃, SiO_{z}, SiO₂, SiO₂/SiOₓ/SiO₂ (0.03≦x≦0.95), SiO_{1.40-20.0}/SiO_{0.70-0.99}/SiO_{1.40-2.0}, or Si/SiO_{z} with 0.70≦z≦2.0 and
(b) a layer of a metal oxide of high refractive index on the substrate selected from the group consisting of ZrO₂, Fe₂O₃, or TiO₂; or
(a) a transparent substrate having a low index of refraction selected from the group consisting of natural, or synthetic mica, another layered silicate, glass, Al₂O₃, SiO_{z}, especially SiO₂, SiO₂/SiOₓ/SiO₂ (0.03≦x≦0.95), SiO_{1.40-2.0}/SiO_{0.70-0.99}/SiO_{0.40-2.0}, or Si/SiO_{z} with 0.70≦z≦2.0, and
(b) a reflecting layer or a semitransparent layer, or a semitransparent metal layer; or
(a) a platelet shaped titanium dioxide substrate,
(b) a layer of Fe₂O₃, Fe₃O₄, FeOOH, Cr₂O₃, CuO, Ce₂O₃, Al₂O₃, SiO₂, BiVO₄, NiTiO₃, CoTiO₃ and also antimony-doped, fluorine-doped or indium-doped tin oxide; or
(a) a platelet shaped iron oxide substrate,
b) a colorless coating having a refractive index n≦1.8, and
c) a colorless coating having a refractive index≧2.0.

6. The process of claim 5 wherein the particles are flakes having the following layer structure:

| | | | |
|---|---|---|---|
| TRASUB | TiO₂ | | |
| TRASUB | TiO_{suboxides} | | |
| TRASUB | TiO₂ | TiN | |
| TRASUB | TiO₂ | SiO₂ | |
| TRASUB | TiO₂ | TiO_{suboxides} | |
| TRASUB | TiO₂ | TiON | TiN |
| TRASUB | TiO₂ | SiO₂ | TiO₂ |
| TRASUB | TiO₂ | SiO₂ | SiO_{suboxides} |
| TRASUB | TiO₂ | SiO₂ | Fe₂O₃ |
| TRASUB | TiO₂ | SiO₂ | TiO₂/Fe₂O₃ |
| TRASUB | TiO₂ | SiO₂ | (Sn,Sb)O₂ |
| TRASUB | (Sn,Sb)O₂ | SiO₂ | TiO₂ |
| TRASUB | Fe₂O₃ | SiO₂ | (Sn,Sb)O₂ |
| TRASUB | TiO₂/Fe₂O₃ | SiO₂ | TiO₂/Fe₂O₃ |
| TRASUB | Cr₂O₃ | SiO₂ | TiO₂ |
| TRASUB | Fe₂O₃ | SiO₂ | TiO₂ |
| TRASUB | TiO_{suboxides} | SiO₂ | TiO_{suboxides} |
| TRASUB | TiO₂ | SiO₂ | TiO₂ + SiO₂ + TiO₂ |
| TRASUB | TiO₂ + SiO₂ + TiO₂ | SiO₂ | TiO₂ + SiO₂ + TiO₂ |
| TRASUB | TiO₂ | Al₂O₃ | TiO₂ |
| TRASUB | Fe₂TiO₅ | SiO₂ | TiO₂ |
| TRASUB | TiO₂ | SiO₂ | Fe₂TiO₅/TiO₂ |
| TRASUB | TiO₂ | SiO₂ | MoS₂ |
| TRASUB | TiO₂ | SiO₂ | Cr₂O₃ |
| TRASUB | TiO₂ | SiO₂ | TiO₂ + SiO₂ + TiO₂ + |
| | | | Prussian Blue |
| TRASUB | TiO₂ | STL | |

wherein TRASUB is a transparent substrate having a low index of refraction selected from the group consisting of natural, or synthetic mica, another layered silicate, glass, Al₂O₃, SiO_{z}, SiO₂, SiO₂/SiOₓ/SiO₂ (0.03≦x≦0.95), SiO_{1.40-2.0}/SiO_{0.70-0.99}/SiO_{1.40-2.0}, or Si/SiO_{z} with 0.70≦z≦2.0, and
STL is a semi-transparent layer selected from the group consisting of a semi-transparent metal layer of Cu, Ag, Cr, or Sn, or a semi-transparent SiO_{suboxides}, TlO_{suboxides} or carbon layer.

7. A process for the treatment of particles according to claim 1, comprising
(A) providing platelet-like particles, comprising
(a) a transparent substrate having a low index of refraction selected from the group consisting of natural, or synthetic mica, another layered silicate, glass, Al₂O₃, SiO_{z}, SiO₂, SiO₂/SiOₓ/SiO₂ (0.03≦x≦0.95), SiO_{1.40-2.0}/SiO_{0.70-0.99}/SiO_{1.40-2.0}, or Si/SiO_{z} with 0.70≦z≦2.0,
(b) a layer of titanium oxide in the anatase modification on the substrate, and (c) optionally a tin oxide layer between the substrate (a) and the layer (b),
(B) entraining said particles in a stream of gas for transport to a plasma torch;
(C) creating a plasma in said stream of gas to heat the outer surface of the particles;
(D) permitting said particles to cool so as to form solid particles; and
(E) collecting the platelet-like particles, comprising
(a) a transparent substrate having a low index of refraction selected from the group consisting of natural, or synthetic mica, another layered silicate, glass, Al₂O₃, SiO_{z}, SiO₂, SiO₂/SiOₓ/SiO₂ (0.03≦x≦0.95), SiO_{1.40-2.0}/SiO_{0.70-0.99}/SiO_{1.40-2.0}, or Si/SiO_{z} with 0.70≦z≦2.0,
(b) a layer of titanium oxide in the rutile modification on the substrate, and optionally a
(c) tin oxide layer between the substrate (a) and the layer (b).

8. The process of claim 1 wherein the particles are flakes, comprising
(a) a metallic platelet-shaped substrate selected from the group consisting of titanium, silver, aluminum, copper, chromium, iron, germanium, molybdenum, tantalum, or nickel, and
(b) a layer of a metal oxide of low refractive index or of high refractive index on the substrate
(c) an optional layer comprising a semi-transparent metal oxide selected from the group consisting of SiO_{z}, SiO₂/SiO_{z}, TiO_{suboxides}, TiO₂/TiO_{suboxides} and 0.70≦z≦2.0.

9. The process of claim 1 wherein the particles are flakes, comprising
(a) a transparent substrate having a low index of refraction selected from the group consisting of natural, or synthetic mica, another layered silicate, glass, Al₂O₃, SiO_{z}, SiO₂, SiO₂/SiOₓ/SiO₂ (0.03≦x≦0.95), SiO_{1.40-2.0}/SiO_{0.70-0.99}/SiO_{1.40-2.0}, or Si/SiO_{z} with 0.70≦z≦2.0, and
(b) a titanium dioxide layer,
(c) a layer of hydrous aluminum oxide, a layer of hydrated zirconium oxide, a top layer comprising hydrated zirconium oxide obtained by hydrolysis in the presence of a hypophosphite, and a hydrated metal oxide, or a combination of hydrated cerium and aluminum oxides, are treated by the process of the present invention, a layer (topcoat) which contains a polysiloxane and a rare earth metal compound.

10. A process for the treatment of particles according to claim 1, comprising
(A) providing platelet-like mica particles,
(B) entraining said particles in a stream of gas for transport to a plasma torch;
(C) creating a plasma in said stream of gas to heat the outer surface of the particles;
(D) permitting said particles to cool so as to form solid particles; and
(E) collecting platelet-like mica particles.

11. The process of claim 1, wherein the particles provided in step (A) are platelet-like particles, comprising
(a) a core and
(b) a polymeric coating, comprising nitrogen and carbon atoms, on the surface of the flakes.

12. The process of claim 1 wherein the particles collected in step (E) comprise
(a) a substrate, and
(b) a layer of a metal nitride/oxy nitride, TiO_{suboxides} SiO_{z} or SiO₂/SiO_{z}, wherein 0.70≦z≦2.0.

13. A product obtained according to claim 1.

14. A coating, a plastic, a paint, a printing ink, a ceramic or glass or personal care product incorporating particles obtained according to claim 1.

15. The personal care product according to claim 14, wherein the personal care product is a body-care product for the skin and its adnexa.

16. The body-care product according to claim 15, wherein the body-care product is selected from the group consisting of skin-care products, bath and shower additives, preparations containing fragrances and odoriferous substances, hair-care products, and decorative preparations.

17. The body-care product according to claim 15, wherein the body-care products are selected from the group consisting of body oils, body lotions, body gels, treatment creams, skin protection ointments, shaving preparations and skin powders.

18. The product according to claim 13, wherein the product is a preparation containing fragrances and odoriferous substances which are selected from scents, perfumes, toilet waters and shaving lotions.

19. The product according to claim 13, wherein the product is a hair-care product selected from the group consisting of shampoos, hair conditioners, products for styling and treating hair, perming agents, hair sprays and lacquers, hair gels, hair fixatives and hair dyeing or bleaching agents.

20. The product according to claim 16, wherein the product is a decorative preparation selected from the group consisting of lipsticks, nail varnishes, eye shadows, mascaras, dry and moist make-up, rouge, powders, depilatory agents and suntan lotions.
